(19) United States
(12) Patent Application Publication
(10) Pub. No.: US 2025/0101282 A1
(43) Pub. Date: Mar. 27, 2025

(54) LIGNIN-ACRYLONITRILE POLYMER ADHESIVE MATERIALS

(71) Applicant: UT-Battelle, LLC, Oak Ridge, TN (US)

(72) Inventors: Amit K. Naskar, Knoxville, TN (US); Christopher C. Bowland, Knoxville, TN (US); Nihal S. Kanbargi, Knoxville, TN (US); Zeyang Yu, Knoxville, TN (US)

(21) Appl. No.: 18/897,172

(22) Filed: Sep. 26, 2024

Related U.S. Application Data
(60) Provisional application No. 63/540,780, filed on Sep. 27, 2023.

(51) Int. Cl. C09J 197/00; C08J 5/12; C09J 5/06; C09J 11/04

(52) U.S. Cl. CPC C09J 197/005; C08J 5/128; C09J 5/06; C09J 11/04; C08J 2409/02; C08J 2497/00

(57) ABSTRACT

A polymer blend material comprising the following components: (i) a lignin component; (ii) a nitrile butadiene rubber component; and (iii) a filler component comprising ceramic particles and/or carbon particles having an average primary particle size of 1-100 nm, wherein component (iii) is present in an amount of 0.1-10 wt % by weight of components (i) and (ii); wherein component (i) is present in an amount of about 5 wt % to about 95 wt % by weight of components (i) and (ii), and wherein the blend material may optionally include a PAN-containing homopolymer or copolymer as an additional component. Methods for producing the polymer blend, molded forms thereof, and articles thereof, are also described. Methods for bonding surfaces together by use of the polymer blend are also described.

### CROSS-REFERENCE TO RELATED APPLICATIONS

The present application claims benefit of U.S. Provisional Application No. 63/540,780, filed on Sep. 27, 2023, all of the contents of which are incorporated herein by reference.

### GOVERNMENT SUPPORT

This invention was made with government support under Prime Contract No. DE-AC05-00OR22725 awarded by the U.S. Department of Energy. The government has certain rights in the invention.

### FIELD OF THE INVENTION

The present invention generally relates to polymer blend compositions and adhesive materials. The present invention more particularly relates to lignin-containing and acrylonitrile-containing polymer blends, and more particularly to blends containing a lignin component and a nitrile butadiene rubber component.

### BACKGROUND

Adhesively bonded joints have been used for light weighting in automotive applications as they eliminate fastener weight, drilling of holes, associated stress concentrations and delamination, distribute the load over larger areas, and can incorporate dissimilar materials substrates. Commonly used adhesives can be classified as, for example, solution-based (polyvinyl acetates, polyurethanes, acrylates, and natural/synthetic rubbers), hot-melt adhesives (generally based on thermoplastic polymer such as saturated polyesters, polyamides, and ethylene-vinyl acetate copolymers), 1-component adhesives (polyurethanes, silane, and cyanoacrylates), 2-component adhesives (the typical example is epoxy), and pressure sensitive adhesives (acrylates and rubbers). However, the existing adhesives are often deficient in retaining their joining strengths over long performance time in critical applications. The existing adhesives are also generally one-time cure (typically thermoset) compositions with no capability of being repaired, re-used, or recycled. Those crosslinked or thermoset adhesives, however, exhibits excellent creep resistance.

There would be a substantial benefit in new thermoplastic adhesive formulations that possess exceptional bonding strength for use in critical applications along with the capability of being repaired, re-used, and recycled. There would be a further benefit in such adhesive materials being solvent-free. There would be a further benefit in adhesive materials containing one or more bio-based components to reduce the carbon footprint and function as a more environmentally friendly alternative.

### SUMMARY

In one aspect, the present disclosure is directed to polymer blend compositions possessing exceptional adhesive abilities along with a thermoplastic property that permits its repair, re-use, and recycling. The polymer blend compositions described herein also advantageously do not require solvents and contain lignin as an environmentally friendly bio-based component, which thus reduces reliance on petroleum-based materials and makes them more environmentally friendly. Thus, the polymer blends described herein represent a significant advance in the field of adhesive materials.

More particularly, the polymer blend material includes the following components: (i) a lignin component; (ii) a nitrile butadiene rubber (NBR) component; and (iii) a filler component comprising ceramic particles and/or carbon particles having an average primary particle size of 1-100 nm, wherein component (iii) is present in an amount of 0.1-10 wt % (or, for example, 1-10 wt %, 1-7 wt %, or 1-5 wt %) by weight of components (i) and (ii); wherein component (i) is present in an amount of about 5 wt % to about 95 wt % by weight of components (i) and (ii). In some embodiments, the ceramic particles are high structure ceramic particles, which means that the primary ceramic particles (of 1-100 nm spherical size) have the ability to assemble into linear or branched or hierarchical beaded or necklace-like clustered structures, typically in the micron length range. Such a structure permits a higher degree of dispersion when mixed with a matrix material. The lignin may be, for example, a hardwood lignin, softwood lignin, organosolv lignin, or grass-derived lignin, and may be present in an amount of about 30 wt % to about 70 wt % (or about 40 wt % to about 60 wt %) by weight of components (i) and (ii). In some embodiments, the lignin is dispersed in component (ii) in the form of domains having a size of up to 1000 nm. The ceramic particles may more particularly be, for example, ceramic oxide, ceramic carbide, or ceramic nitride particles, or composite particles containing two or more of these or other compositions. In more particular embodiments, the ceramic particles are silica particles, or more particularly, fumed silica (FS) particles. In some embodiments, component (iii) includes the ceramic particles in admixture with epoxy-functionalized ceramic particles such as epoxy functionalized glass spheres, epoxy functionalized silica, or an epoxy functionalized polyhedral oligomeric silsesquioxane (POSS) particles. In separate or further embodiments, component (ii) may have an acrylonitrile content of at least or above 40 mol %, 45 mol %, 50 mol %, or 55 mol %. In separate or further embodiments, the polymer blend material may further include: (iv) a polyacrylonitrile-containing (PAN-containing) polymer blended with components (i), (ii), and (iii). Such mixing of PAN with component (ii) preferably enhances the acrylonitrile content in NBR material to a level greater than 55 mol %. In embodiments, the PAN-containing polymer is a homopolymer or a copolymer of acrylonitrile with at least 80 mole % nitrile content. In some embodiments, the mixture of components (i), (ii), (iii) is very lightly crosslinked to enhance the toughness of the adhesive component. The crosslinking, in some embodiments, is achieved via use of 0-5 parts of organic peroxide per hundred parts of NBR rubber.

In a second aspect, the present disclosure is directed to a method of bonding first and second surfaces together. In a first variation of the method, the method includes placing an adhesive composition containing ceramic particles as the filler component in contact with and between the first and second surfaces and hot pressing the surfaces at a temperature of 80° C. to 200° C. In a second variation of the method, the method is the same as above, except that the filler component contains carbon particles (e.g., carbon nanotubes, nanospheres, graphene, activated carbon, or carbon black), which may be in place of or in combination with ceramic particles. The carbon particles, if present, can be present in any of the weight ranges provided above for the ceramic particles. In any of the variations provided above, the hot-pressing temperature may more specifically be in the range of, for example, 80° C. to 180° C., or 80° C. to 150° C., or 80° C. to 120° C. The first and second surfaces may be, for example, metal surfaces, ceramic surfaces, glass surfaces, or polymer matrix composite surfaces, or any combination of such surfaces. The method may also include a subsequent step of reheating the bonded (adhered) surfaces to soften the polymer blend adhesive for the purpose of repairing defects in the adhesive, or for the purpose of removing the adhesive to re-use or recycle it.

### BRIEF DESCRIPTION OF THE FIGURES

FIGS. 1a-1u. FIGS. 1a-1e, 1f-1j, and 1k-1o show the σ₁₁ distribution at different level of ε_{avg} within 2, 5, and 7 wt. % FS-contained composites, respectively; FIGS. 1p-1r depict the plastic strain in the X direction (PS₁₁) distribution within the representative volume elements (RVEs) with 2, 5, and 7 wt. % FS, respectively, at their peak stress (the load was applied in the X direction); (s) summarize computational peak stress; FIGS. 1t-1u show the experimental tensile strength and lap shear strength (LSS) for ABL-based adhesives, respectively. Note: ABL is an acronym for “acrylonitrile butadiene lignin” which corresponds to a blend of components (i) and (ii); and FS=fumed silica.

FIG. 2. Graphs showing experimental tensile and adhesion properties of ABL-FS-EGS adhesives, wherein FIG. 2a shows results for tensile strength and FIG. 2b shows LSS results; and EGS=epoxidized glass spheres.

FIGS. 3a-3b. FTIR spectra for ABL-FS adhesive formulation (FIG. 3a) and ABL-FS-EGS adhesive formulation (FIG. 3b).

FIGS. 4a-4d. Graphs showing rheological and dynamic-mechanical properties of ABL-based adhesives. FIG. 4a plots the complex viscosities of ABL-FS adhesives (160° C.). FIG. 4b plots the complex viscosities of ABL-FS-EGS adhesives (160° C.). FIG. 4c plots the mechanical damping factor (tan δ) of ABL-FS adhesives. FIG. 4d plots the mechanical damping factor (tan δ) of ABL-FS-EGS adhesives.

FIGS. 5a-5b. Data demonstrating recyclability of the thermoplastic ABL adhesive. FIG. 5a is a schematic illustration of the testing and recycling process. FIG. 5b is a graph showing LSS results for the recyclable ABL-FS-EGS adhesive.

FIGS. 6a-6b. Data demonstrating lignin-induced anti-aging behavior of ABL-FS-EGS adhesive. FIG. 6a is a graph showing LSS analysis comparing the baseline sample with the adhesive film sample stored for one year at ambient condition. FIG. 6b is an FTIR spectrum of the baseline sample versus the sample stored for one year at ambient condition.

FIG. 7. Graph showing LSS results for different substrates. ABL: ABL-FS-EGS adhesive; ABL-Plasma: the substrate was plasma treated to enhance adhesion behavior; Epoxy: a commercial epoxy adhesive; Al 7075:7075 aluminum alloy; DP980: dual phase 980 steel; CFRP: carbon fiber reinforced thermoset polymer composite.

FIG. 8. LSS data showing the effect of additional loading of 5 parts of polyacrylonitrile (PAN) and 0.5 parts of dicumyl peroxide (DCP) per 100 parts of NBR in partially crosslinked ABL-FS-EGS adhesive for aluminum 6061 joints.

### DETAILED DESCRIPTION

In a first aspect, the present disclosure is directed to polymer blend compositions that include: (i) a lignin component; (ii) a nitrile butadiene rubber (NBR) component, and (iii) a filler component comprising ceramic particles having an average primary particle size of 1-100 nm. The term “blend” (or more particularly, “polymer blend”), as used herein, refers to a solid solution in which discrete microscopic regions of components (i) and/or (ii) are present. The polymer blend may exhibit substantial integration (i.e., near homogeneous) or complete integration at the microscale or approaching the molecular level, but without losing each component's identity. Generally, component (ii) (i.e., NBR) functions as a matrix in which the lignin component (i) is dispersed. The acronym “ABL” represents acrylonitrile-butadiene-lignin rubbers referring to a blend of the lignin and NBR.

In the polymer blend material, the lignin component is dispersed in the NBR matrix in the form of domains. Depending on the lignin type and the nitrile content in NBR, the lignin domains can be as large as 10 μm. Very large lignin domains (e.g., over 1 μm) may result in undesirable effects in the mechanical properties of the blends. Generally, the smaller the lignin domains, the better the mechanical properties of the polymer blend material. In exemplary blends, the lignin domains have a size up to or less than 1000 nm (1 μm). In different embodiments, the lignin domains have a size up to or less than, for example, 1000 nm, 800 nm, 500 nm, 200 nm, 100 nm, 50 nm, 25 nm, 20 nm, 10 nm, 8 nm, 5 nm, 4 nm, 3 nm, 2 nm, or 1 nm, or a domain size within a range bounded by any two of the foregoing values (e.g., 1-1000 nm, 2-1000 nm, 1-100 nm, or 2-100 nm). In some embodiments, the domain size is exceptionally small, e.g., 1-10 nm, 2-10 nm, 1-8 nm, 2-8 nm, 1-5 nm, or 2-5 nm. Any of the foregoing exemplary domain sizes may alternatively represent a mean or median domain size, as found in a particle size distribution curve. For example, in some embodiments, at least 80%, 85%, 90%, or 95% of the lignin domains have a size up to or less than any exemplary values provided above. In some embodiments, substantially all (e.g., above 95%) or all (i.e., 100%) of the lignin domains have a size up to or less than any exemplary values provided above.

The lignin can be any of the wide variety of lignin compositions found in nature in lignocellulosic biomass and as known in the art. As known in the art, the lignin compositions found in nature are generally not uniform. Lignin is a random copolymer that shows significant compositional variation between plant species. Many other conditions, such as environmental conditions, age, and method of processing, influence the lignin composition.

Lignins are very rich aromatic compounds containing many hydroxyl (also possible carboxylic) functional groups attached differently as both aliphatic and phenolic groups. Additionally, some lignins possess highly branched structures. These characteristics of lignins determine their corresponding physical properties. The molar mass or molecular weight (M_{w}) of the lignin is generally broadly distributed, e.g., from approximately 1000 Dalton (D) to over 10,000 D. In typical embodiments, the lignin may have a number-average or weight-average molecular weight (i.e., Mₙ or M_{w}, respectively) of about, up to, or less than, for example, 300, 500, 1,000, 3,000, 5,000, 8,000, 10,000, 50,000, 100,000, 500,000 or 1,000,000 g/mol, or a weight within a range bounded by any two of the foregoing values, such as 500-10,000 g/mol or 500-5,000 g/mol [G. Fredheim, et al., J. Chromatogr. A, 2002, 942, 191; and A. Tolbert, et al., Biofuels, Bioproducts & Biorefining 8 (6) 836-856 (2014)] wherein the term “about” generally indicates no more than +10%, +5%, or +1% from an indicated value.

The lignin generally contains phenyl rings interconnected by the typical linking groups known to be in lignin, e.g., independently selected from one or more of ether (—O—) and alkylene linkages (e.g., —CH₂—, —CH₂CH₂—, —CH₂CH₂CH₂—, or —CH₂CH(CH₃)—) and wherein hydroxy and/or methoxy groups are attached to the phenyl rings. The alkylene linkages can be linear or branched, but typically, at least a portion of the alkylene linkages are branched. Typically, the phenyl rings are interconnected by linkages containing both ether and alkylene portions, e.g., —OCH(R)—, —OCH(R)CH(R)—, OCH(R)CH(R)CH(R)—, —OCH(CH₂OH)—, or —OCH(OH) CH(CH₂OH)—, where R can be, for example, H, OH, CH₂OH, or —O—. Thus, at least a portion of the linkages connecting phenyl rings are also typically substituted with hydroxy groups. The lignin structure typically includes ether (—O—) linkages and C—C covalent linkages. Some of these C—C covalent linkages can be alkylene linkages as mentioned earlier and wherein hydroxy and/or methoxy groups are attached to the phenyl rings.

In some embodiments, the lignin is significantly deploymerized when isolated from its native biomass source and has a molar mass of less than 1000 D. Their natural branches and low M_{w} generally result in very brittle characteristics. The aromatic structures and rich functional groups of lignins also lead to varied rigid and thermal properties. Lignins are amorphous polymers, which results in very broad glass transition temperatures (T_{g}), from ca. 80° C. to over 200° C. The glass transition temperatures are critical temperatures at which the lignin macromolecular segments become mobile. Some lignins exhibit a very good flow property (low molten viscosity), whereas others display several orders of magnitude higher viscosity.

Lignins differ mainly in the ratio of three alcohol monomer units, i.e., p-coumaryl alcohol, guaiacyl alcohol, and sinapyl alcohol. The polymerization of p-coumaryl alcohol, coniferyl alcohol, and sinapyl alcohol forms the p-hydroxyphenyl (H), guaiacyl (G) and syringyl(S) components of the lignin polymer, respectively. The lignin can have any of a wide variety of relative weight percents (wt %) of H, G, and S components or their derivatives. As observed in some seeds, lignin may also consist of caffeyl alcohol units, e.g., Chen et al., Proc. Natl. Acad. Sci. U.S.A, 109 (5), 1772-1777 (2012). For example, the precursor lignin may contain, independently for each component, at least, up to, or less than 1 wt %, 2 wt %, 5 wt %, 10 wt %, 20 wt %, 30 wt %, 40 wt %, 50 wt %, 60 wt %, 70 wt %, 80 wt %, or 90 wt %, or within a range thereof, of any of the caffeyl alcohol, H, G, and S components. Typically, the sum of the wt % of each alcohol component is 100%, or at least 98% if other minor components are considered. Different wood and plant sources (e.g., hardwood (HW), such as oak, maple, poplar, and the like; softwood (SW), such as pine, spruce, and the like; or grass or perennial plant-derived lignins, such as switch grass, corn, bamboo, perennial grass, orchard grass, alfalfa, wheat, miscanthus, bamboo, and bagasse) often widely differ in their lignin compositions, and are all considered herein as sources of lignin. In some embodiments, depending on the desired characteristics of the emulsion or hierarchical assembly, any one or more types of lignin, as described above, may be excluded from the composition.

Besides the natural variation of lignins, there can be further compositional variation based on the manner in which the source lignin has been processed. For example, the source lignin can be a Kraft lignin, sulfite lignin (i.e., lignosulfonate), or a sulfur-free lignin. As known in the art, a Kraft lignin refers to lignin that results from the Kraft process. In the Kraft process, a combination of sodium hydroxide and sodium sulfide (known as “white liquor”) is reacted with lignin present in biomass to form a dark-colored lignin bearing thiol groups. Kraft lignins are generally water- and solvent-insoluble materials with a high concentration of phenolic groups. They can typically be made soluble in aqueous alkaline solution. As also known in the art, sulfite lignin refers to lignin that results from the sulfite process. In the sulfite process, sulfite or bisulfite (depending on pH), along with a counterion, is reacted with lignin to form a lignin bearing sulfonate (SO₃H) groups. The sulfonate groups impart a substantial degree of water-solubility to the sulfite lignin.

There are several types of sulfur-free lignins known in the art, including lignin obtained from biomass conversion technologies (such as those used in ethanol production), solvent pulping (i.e., the “organosolv” process), soda pulping (i.e., “soda lignin”), and supercritical water fractionation or oxidation (i.e., “supercritical water fractionated lignin”). In particular, organosolv lignins are obtained by solvent extraction from a lignocellulosic source, such as chipped wood, followed by precipitation. The solvent system in organosolv delignification of biomass often include organic alcohols, such as methanol, ethanol, propanol, butanol, and isobutyl alcohol; aromatic alcohols, such as phenol and benzyl alcohol; glycols, such as ethylene glycol, triethylene glycol, propylene glycol, butylene glycol and other higher glycols; ketones, such as acetone, methyl ethyl ketone and methyl isobutyl ketone; organic acids, such as formic acid, acetic acid and propionic acid, amines, aldehydes, esters, organic nitrile compounds, diethyl ether, dioxane, glycerol, or mixture of these solvents. Typically, some degree of dilute acid pretreatment of biomass helps the delignification process. Due to the significantly milder conditions employed in producing organosolv lignins (i.e., in contrast to Kraft and sulfite processes), organosolv lignins are generally more pure, less degraded, and generally possess a narrower molecular weight distribution than Kraft and sulfite lignins. These lignins can also be thermally devolatilized to produce a variant with less aliphatic hydroxyl groups, and molecularly restructured forms with an elevated softening point. Any one or more of the foregoing types of lignins may be used (or excluded) as a component in the compositions and methods described herein.

The lignin may also be an engineered form of lignin having a specific or optimized ratio of H, G, and S components. Lignin can be engineered by, for example, transgenic and recombinant DNA methods known in the art that cause a variation in the chemical structure in lignin and overall lignin content in biomass (e.g., F. Chen, et al., Nature Biotechnology, 25 (7), pp. 759-761 (2007) and A. M. Anterola, et al., Phytochemistry, 61, pp. 221-294 (2002)). The engineering of lignin is particularly directed to altering the ratio of G and S components of lignin (D. Guo, et al., The Plant Cell, 13, pp. 73-88, (January 2001). In particular, wood pulping kinetic studies show that an increase in S/G ratio significantly enhances the rate of lignin removal (L. Li, et al., Proceedings of The National Academy of Sciences of The United States of America, 100 (8), pp. 4939-4944 (2003)). The S units become covalently connected with two lignol monomers; on the other hand, G units can connect to three other units. Thus, an increased G content (decreasing S/G ratio) generally produces a highly branched lignin structure with more C—C bonding. In contrast, increased S content generally results in more β-aryl ether (β-O-4) linkages, which easily cleave (as compared to C—C bond) during chemical delignification, e.g., as in the Kraft pulping process. It has been shown that decreasing lignin content and altering the S/G ratio improve bioconvertability and delignification. Thus, less harsh and damaging conditions can be used for delignification (i.e., as compared to current practice using strong acid or base), which would provide a more improved lignin better suited for higher value applications.

Lab-scale biomass fermentations that leave a high lignin content residue have been investigated (S. D. Brown, et al., Applied Biochemistry and Biotechnology, 137, pp. 663-674 (2007)). These residues will contain lignin with varied molecular structure depending on the biomass source (e.g., wood species, grass, and straw). Production of value-added products from these high quality lignins would greatly improve the overall operating costs of a biorefinery. Various chemical routes have been proposed to obtain value-added products from lignin (J. E. Holladay, et al., Top Value-Added Chemicals from Biomass: Volume II—Results of Screening for Potential Candidates from Biorefinery Lignin, DOE Report, PNNL-16983 (October 2007)).

The lignin may, in some embodiments, be a crosslinked lignin that is melt-processible or amenable to melt-processing. The term “crosslinked” can mean, for example, that the lignin contains methylene (i.e., —CH₂—) and/or ethylene (i.e., —CH₂CH₂—) linkages (i.e., linking groups) between phenyl ring carbon atoms in the lignin structure. In some embodiments, a mild polycondensation condition can be used, such as by formaldehyde crosslinking of phenols or self-condensation by reaction between carboxylic acid and aliphatic hydroxy groups in the presence of appropriate catalysts to yield branched segments from these functionally enriched oligomers. By being “melt-processible” is meant that the crosslinked lignin can be softened, sheared, and melted or converted to a molten, highly viscous, or rubbery state starting at a particular glass transition temperature. The melted or highly viscous lignin can then be more easily processed, such as by mixing, molding, applying on a surface, or dissolving in a solvent. In some embodiments, the lignin is not crosslinked.

In some embodiments, the lignin exhibits a suitable steady shear viscosity to render it as a malleable film-forming material at the processing temperature and shear rate employed. Typically, at a low-shear melt processing condition (e.g., at 1-100 s⁻¹ shear rate regime), the steady shear viscosity of the lignin component is at least or above 100 Pa·s, 500 Pa·s, 1000 Pa·s, 3000 Pa·s, or 5000 Pa·s, or within a range therein. In some embodiments, the lignin forms a highly viscous melt (on the order of 10,000 Pa·s complex viscosity or higher) at a 100 s⁻¹ shear rate. In some embodiments, the lignin may be oxidized (e.g., by exposure to a chemical oxidizing agent), while in other embodiments, the lignin is not oxidized. In some embodiments, the lignin is chemically unmodified relative to its natural extracted or isolated form. In some embodiments, the lignin is chemically modified by acetylation, oxypropylation, hydroxymethylation, epoxidation, or the like, as known in the art. In some embodiments, the lignin is plasticized with solvents or plasticizers to induce melt-processability. Solvents and plasticizers include, for example, dimethylsulfoxide, dimethylacetamide, polyoxyalkylene, ethylene carbonate, propylene carbonate, and glycerol, as known in the art. In some embodiments, the use of a solvent or plasticizer is excluded.

In different embodiments, the lignin (either isolated or extracted lignin from biomass or its crosslinked derivative) has a glass transition temperature of precisely or about, for example, 40° C., 50° C., 60° C., 70° C., 80° C., 90° C., 100° C., 105° C., 110° C., 115° C., 120° C., 125° C., 130° C., 140° C., 150° C., 160° C., 170° C., 180° C., 190° C., 200° C., 210° C., 220° C., 230° C., or 240° C., or a T_{g} within a range bounded by any two of the foregoing values. In some embodiments, the lignin does not exhibit a detectable T_{g}, unless mixed with a plasticizing component such as solvent, or polymeric additives. In some embodiments, lignin undergoes a degradation reaction before exhibiting a discernible T_{g}.

The lignin (in either raw form isolated from biomass or a crosslinked derivative) may be substantially soluble in a polar organic solvent or aqueous alkaline solution. As used herein, the term “substantially soluble” generally indicates that at least 1, 2, 5, 10, 20, 30, 40, 50, or 60 grams of the lignin completely dissolves in 1 deciliter (100 mL) of the polar organic solvent or aqueous alkaline solution. In other embodiments, the solubility is expressed as a wt % of the lignin in solution. In some embodiments, the lignin has sufficient solubility to produce at least a 5 wt %, 10 wt %, 15 wt %, 20 wt %, 30 wt %, 40 wt %, or 50 wt % solution in the polar organic solvent or aqueous alkaline solution. The polar organic solvent can be aprotic or protic. Some examples of polar aprotic solvents include the organoethers (e.g., diethyl ether, tetrahydrofuran, and dioxane), nitriles (e.g., acetonitrile, propionitrile), sulfoxides (e.g., dimethylsulfoxide), amides (e.g., dimethylformamide, N,N-dimethylacetamide), organochlorides (e.g., methylene chloride, chloroform, 1,1,-trichloroethane), ketones (e.g., acetone, 2-butanone), and dialkylcarbonates (e.g., ethylene carbonate, dimethylcarbonate, diethylcarbonate). Some examples of polar organic protic solvents include the alcohols (e.g., methanol, ethanol, isopropanol, n-butanol, t-butanol, the pentanols, hexanols, octanols, or the like), diols (e.g., ethylene glycol, diethylene glycol, triethylene glycol), and protic amines (e.g., ethylenediamine, ethanolamine, diethanolamine, and triethanolamine). The aqueous alkaline solution can be any aqueous-containing solution having a pH of at least (or over) 8, 9, 10, 11, 12, or 13. The alkalizing solute can be, for example, an alkali hydroxide (e.g., NaOH or KOH), ammonia, or ammonium hydroxide. Combinations of any of these solvents may also be used.

In some embodiments, the lignin is dissolved in a solvent, such as any of the solvents described above, when used to form the polymer blend. The solvent may or may not be incorporated into the polymer blend material. In some embodiments, one or more classes or specific types of solvents are excluded from any of the components (i) or (ii) or from the polymer blend material altogether.

The nitrile butadiene rubber (NBR) component, i.e., component (ii), also known as “nitrile rubber,” is a copolymer constructed of (i.e., derived from) acrylonitrile (AN) units and butadiene (BD) units. The term “copolymer,” as used herein, indicates the presence of at least AN and BD units, wherein the at least two types of units are typically present in the copolymer in random form, but in some cases may be present as blocks (i.e., segments), or in alternating, periodic, branched, or graft form. In some embodiments, the nitrile rubber contains acrylonitrile and butadiene units along with one or more other monomer units, such as one or more of styrene, divinyl benzene, isoprene, acrylate, and/or methacrylate units, provided that the nitrile rubber maintains a rubber (elastic) property if one or more other monomeric units is present. In other embodiments, the nitrile rubber contains only acrylonitrile and butadiene units.

The nitrile rubber generally has a T_{g} that is below room temperature. Because of its extended dipolar interactions and entanglements between high molecular weight rubbery segments, it generally behaves like a partially crosslinked or elastomeric material. The nitrile rubber generally possesses the known physical attributes of nitrile butadiene rubber materials of the art, such as a substantial extensibility, as generally evidenced in a typical ultimate elongation of at least 50%, 100%, 150%, 200%, 250%, 300%, 400%, 500%, 1000%, or 2000%. In some embodiments, the nitrile rubber component contains functionalizing groups aside from nitrile and unsaturated carbon-carbon bonds, such as carboxy, hydroxy, ester, amino, or epoxy groups. In other embodiments, one or all of such functionalizing groups (aside from nitrile) are excluded from the nitrile rubber component. In some embodiments, any functionalizing groups capable of reacting with the lignin component (e.g., phenol- or hydroxy-reactive groups, such as epoxy or aldehyde groups) to form covalent bonds therewith are not present in the nitrile rubber component.

The nitrile rubber component can also have any of a wide range of weight-average molecular weights (M_{w}), such as precisely, about, at least, above, up to, or less than, for example, 2,500 g/mol, 3,000 g/mol, 5,000 g/mol, 10,000 g/mol, 50,000 g/mol, 100,000 g/mol, 150,000 g/mol, 200,000 g/mol, 300,000 g/mol, 400,000 g/mol, 500,000 g/mol, or 1,000,000 g/mol, or a molecular weight within a range bounded by any two of the foregoing exemplary values. The nitrile rubber component may also have any of a wide range of number-average molecular weights Mₙ, wherein n can correspond to any of the numbers within the range provided above for M_{w}.

The nitrile rubber component can have any acrylonitrile content known in the art. In some embodiments, the nitrile rubber has an acrylonitrile content of at least or above 20 mol %. In different embodiments, the acrylonitrile rubber component has an acrylonitrile content of about, at least, or above 20, 25, 30, 33, 35, 38, 40, 42, 45, 48, 50, 52, 55 or 60 mol %, or an acrylonitrile content within a range bounded by any two of the foregoing values.

Most common commercial nitrile rubber grades contain approximately 25-50 mole % acrylonitrile in the copolymer rubber composition. The higher the acrylonitrile content in rubber, higher is the T_{g} and hardness of the NBR rubber. To further enhance acrylonitrile content in the commercial copolymer rubber composition, in some embodiments, polyacrylonitrile or PAN (synthesized and purified in dry powder form), which may be a homopolymer of copolymer of PAN, can be mixed with NBR rubber. Such addition of PAN to NBR can increase acrylonitrile content in the rubber composition to a level of at least or above 55 mol % or 60 mol %.

In the polymer blend material, the lignin component (i) is present in an amount of at least 5 wt. % and up to about 95 wt. % by total weight of components (i) and (ii). As both components (i) and (ii) are present in the polymer blend, each component must be in an amount less than 100 wt. %. In different embodiments, the lignin component is present in the polymer blend material in an amount of about, at least, or above, for example, 5, 10, 15, 20, 25, 30, 35, 40, 45, 50, 55, 60, 65, 70, 75, 80, 90, or 95 wt. %, or in an amount within a range bounded by any two of the foregoing exemplary values, e.g., at least or above 15, 20, 25, 30, 35, or 40 wt. %, and up to 45, 50, 55, 60, 65, or 70 wt. % by total weight of components (i) and (ii). In more particular embodiments, the lignin component is present in an amount of 20, 25, 30, 35, or 40 wt. %, and up to 45, 50, 55, or 60 wt. % by total weight of components (i) and (ii), or more particularly, at least 30, 35, or 40 wt. %, and up to 45, 50, or 55 wt. % by total weight of components (i) and (ii). In particular embodiments, component (i) is present in an amount of 30-70 wt. %, 40-70 wt. %, 50-70 wt. %, 55-70 wt. %, 30-65 wt. %, 40-65 wt. %, 50-65 wt. %, 55-65 wt. %, 30-60 wt. %, 40-60 wt. %, or 50-60 wt. % by total weight of components (i) and (ii).

In one set of embodiments, the filler component, i.e., component (iii), contains particles having a ceramic composition (i.e., “ceramic particles”). The ceramic particles can have any of the known ceramic compositions, such as ceramic oxide, ceramic sulfide, ceramic nitride, ceramic carbide, and ceramic boride compositions. Typically, the ceramic composition includes one or more metallic and/or metalloid (main group) elements bonded with oxygen, sulfur, nitrogen, phosphorus, carbon, silicon, or boron atoms, or a combination of two or more of such atoms. The metallic elements include the alkaline earth, transition metal, and lanthanide elements, as found in Groups 2-12 of the Periodic Table. The metalloid elements include the main group metals (typically, Groups 13-15 of the Periodic Table). Thus, the ceramic composition may be, for example, an alkaline earth oxide, transition metal oxide, main group oxide, lanthanide oxide, alkaline earth sulfide, transition metal sulfide, main group sulfide, lanthanide sulfide, alkaline earth nitride, transition metal nitride, main group nitride, lanthanide nitride, alkaline earth carbide, transition metal carbide, main group carbide, lanthanide carbide, alkaline earth boride, transition metal boride, main group boride, and lanthanide boride. Particles, including nanoparticles and microparticles of any of these, are well known in the art. Moreover, the ceramic composition may correspond to a natural mineral composition, such as mullite, quartz, basalt, and clays. The ceramic composition may alternatively be a natural or synthetic zeolite.

Some examples of ceramic oxide compositions include silica (SiO₂), alumina (Al₂O₃), titania (TiO₂), zirconia (TiO₂), yttria (Y₂O₃), hafnia (HfO₂), niobium oxide (e.g., Nb₂O₅), iron oxide (e.g., FeO, Fe₂O₃ and/or Fe₃O₄), cobalt oxide (CoO), nickel oxide (NiO), zinc oxide (ZnO), tin oxide (SnO₂), indium tin oxide, germanium oxide (GeO₂), gallium oxide (Ga₂O₃), indium oxide (In₂O₃), antimony oxide (Sb₂O₃), magnesium oxide (MgO), calcium oxide (CaO), cerium oxide (CeO₂), and lanthanum oxide (La₂O₃). In particular embodiments, the ceramic oxide is silica, or more particularly, fumed silica (FS), as well known in the art. In separate or further embodiments, the ceramic oxide is or includes polyhedral oligomeric silsesquioxane (POSS) particles. In any of the foregoing examples of oxides, the oxygen (O) may be substituted with sulfur(S) to result in a corresponding ceramic sulfide. The ceramic composition may alternatively be a ceramic oxysulfide.

Some examples of ceramic nitride compositions include silicon nitride (Si₃N₄), aluminum nitride (AlN), gallium nitride (GaN), indium nitride (InN), indium gallium nitride, boron nitride (BN), titanium nitride (TiN), zirconium nitride (ZrN), and magnesium nitride (Mg₃N₂). The ceramic nitride may alternatively be a ceramic oxynitride, such as a silicon oxynitride, aluminum oxynitride, gallium oxynitride, indium oxynitride, titanium oxynitride, or zinc oxynitride. In any of the foregoing examples of oxides or oxynitrides, the nitrogen (N) can be substituted with phosphorus (P) or arsenic (As) to result in a corresponding ceramic phosphide or ceramic arsenide, such as GaP, GaAs, InP, InAs, and InGaAs.

Some examples of ceramic carbide compositions include silicon carbide (SiC), titanium carbide, zirconium carbide, tungsten carbide, and boron carbide. In any of the foregoing examples other than SiC, the carbon (C) may be replaced with silicon (Si) to result in a ceramic silicide, such as magnesium silicide and molybdenum disilicide. Notably, for purposes of this invention, the term “ceramic carbide” is understood to not include carbon particles.

Some examples of ceramic boride compositions include aluminum boride, magnesium boride, titanium boride, zirconium boride, yttrium boride, tantalum boride, molybdenum boride, and tungsten boride. In any of the foregoing examples other than aluminum boride, the boron (B) may be replaced with aluminum (Al) to result in a ceramic aluminide, such as boron aluminide, magnesium aluminide, titanium aluminide, yttrium aluminide, zirconium aluminide, iron aluminide, and nickel aluminide.

In another set of embodiments, the filler component, i.e., component (iii), contains particles having a carbon composition (i.e., “carbon particles”). The carbon particles may be in place of or in combination with ceramic particles. The carbon particles, if present in the polymer blend material, can be any of the carbon particles known in the art that are composed substantially of elemental carbon. The carbon particles may be nanoparticles (e.g., at least 1, 2, 5, or 10 nm, and up to 20, 50, 100, 200, or 500 nm), microparticles (e.g., at least 1, 2, 5, or 10 μm, and up to 20, 50, 100, 200, or 500 μm), or macroparticles (e.g., above 500 μm, or at least or up to 1, 2, 5, 10, 20, 50, or 100 mm). Some examples of carbon particles include carbon black (“CB”), graphene, graphene oxide, graphene nanoribbons, carbon onion (“CO”), a spherical fullerene (e.g., buckminsterfullerene, i.e., C₆₀, as well as any of the smaller or larger buckyballs, such as C₂₀ or C₇₀), a tubular fullerene (e.g., single-walled, double-walled, or multi-walled carbon nanotubes), carbon nanodiamonds, and carbon nanobuds, all of which have compositions and physical and electrical properties well-known in the art. As known in the art, fully graphitized carbon nanodiamonds can be considered to be carbon onions. In some embodiments, the filler component excludes carbon particles.

In some embodiments, the carbon particles are composed solely of carbon. In other embodiments, the carbon particles are doped with one or a combination of non-carbon non-hydrogen (i.e., hetero-dopant) elements, such as nitrogen, oxygen, sulfur, boron, silicon, or phosphorus. The amount of doping element is often a minor amount (e.g., up to 0.1, 0.5, 1, 2, or 5 wt. % or mol %) but may be significantly higher (e.g., at least 5, 10, or 20 mol %), particularly in the case of oxygen as dopant. In some embodiments, the carbon particles are selected from graphene, graphene oxide, or a combination thereof. Graphene oxide can have 5-30% heteroatom (oxygen) content. In some embodiments, highly oxidized (oxygen content up to 50%) graphene oxide is used as carbon-based particle. In some embodiments, any one or more of the specifically recited classes or specific types of carbon particles are excluded, or any one or more of the specifically recited classes or specific types of hetero-dopant elements are excluded from the carbon particles.

In some embodiments, the carbon particles can be any of the high strength carbon fiber compositions known in the art. As known in the art, the carbon fiber has its length dimension longer than its width dimension. Carbon fibers can be relatively short (e.g., 1-10 cm) or typical length (e.g., 0.1 m, 1 m, or longer). Some examples of carbon fiber compositions include those produced by the pyrolysis of polyacrylonitrile (PAN), viscose, rayon, pitch, lignin, polyolefins, as well as vapor grown carbon nanofibers, any of which may or may not be heteroatom-doped, such as with nitrogen, boron, oxygen, sulfur, or phosphorus. The carbon fiber typically possesses a high tensile strength, such as at least 500, 1000, 2000, 3000, 5000, 7,000, or 10,000 MPa, or higher, with a degree of stiffness generally of the order of steel or higher (e.g., 100-1000 GPa). The carbon particles may also be chopped versions of a carbon fiber, typically having lengths within a range of 10-1000 microns. In some embodiments, carbon fibers or particles derived therefrom are excluded from the polymer blend.

The particles of the filler generally have an average primary particle size in the range of 1-100 nm. In different embodiments, the particles of the filler have an average primary particle size of precisely or about, for example, 1, 2, 5, 10, 15, 20, 25, 30, 35, 40, 45, 50, 60, 65, 70, 75, 80, 85, 90, 95, or 100 nm, or a particle size within a range bounded by any two of the foregoing values (e.g., 1-100 nm, 1-80 nm, 1-50 nm, 1-40 nm, 1-30 nm, 1-20 nm, 1-10 nm, 1-5 nm, 2-50 nm, 2-40 nm, 2-30 nm, 2-20 nm, 2-10 nm, 2-5 nm, 5-100 nm, 5-80 nm, 5-50 nm, 5-20 nm, or 5-10 nm). The particle size range, which may be any of the foregoing exemplary ranges, may be monomodal, bimodal, or higher modal, and each mode (distribution) may have a peak particle size corresponding to any of the particle sizes provided above.

The ceramic or carbon particles may or may not agglomerate or arrange themselves into micron-length structures. In some embodiments, the ceramic or carbon particles may be referred to as “high structure particles”, which indicates an ability of the particles to assemble into linear or branched or hierarchically beaded or necklace-like clustered structures, typically in the micron-length range. The term “micron-length”, as used herein, typically refers to a length of at least 500 nm, 1000 nm, 2000 nm, 3000 nm, 4000 nm, or 5000 nm, or a length within a range bounded by any two of these values. As known in the art, structure of particles typically influences both dispersion and flocculation of the particles in a polymer matrix [Yu, J., L. Q. Zhang, M. Rogunova, J. Summers, A. Hiltner, and E. Baer. “Conductivity of polyolefins filled with high-structure carbon black.” Journal of applied polymer science 98, no. 4 (2005): 1799-1805.] As well known, fumed silica or fumed alumina can behave as high structure particles [Uchino, T., et al. (2004). Microscopic structure of nanometer-sized silica particles. Physical Review B, 69 (15), 155409].

The ceramic particles or carbon particles may or may not be surface functionalized. In one set of embodiments, the ceramic particles are not surface functionalized (i.e., they are bare). In another set of embodiments, the ceramic particles are surface functionalized. The surface functionalization may be provided by discrete surface functional groups or polymers. The surface functional groups may be, for example, hydroxy, carboxy, amine, epoxy, or thiol groups, or an alkyl or alkenyl chain (or surfactant) containing one or more of any of the foregoing groups. The surface functional polymer may be, for example, a polysiloxane, polyether, polyamine, or polyimine. Particles containing different functional groups may also be used. In some embodiments, any one or more of the foregoing surface functional groups may be excluded from the ceramic particles while one or more other types may be included. In some embodiments, the ceramic particles are not epoxy-functionalized.

The filler component (i.e., ceramic particles, carbon particles, or combination thereof) is typically present in the polymer blend material in an amount of at least 0.1 wt. % and up to 10 wt. % by weight of components (i) and (ii). In different embodiments, the filler component is present in an amount of precisely, about, or at least, for example, 0.1 wt. %, 0.2 wt. %, 0.5 wt. %, 1 wt. %, 1.5 wt. %, 2 wt. %, 2.5 wt. %, 3 wt. %, 3.5 wt. %, 4 wt. %, 4.5 wt. %, 5 wt. %, 5.5 wt. %, 6 wt. %, 6.5 wt. %, 7 wt. %, 7.5 wt. %, 8 wt. %, 8.5 wt. %, 9 wt. %, 9.5 wt. %, or 10 wt. %, or an amount within a range bounded by any two of the foregoing values, e.g., 0.1-10 wt. %, 0.1-8 wt. %, 0.1-5 wt. %, 0.1-4 wt. %, 0.1-3 wt %, 0.5-10 wt. %, 0.5-8 wt. %, 0.5-5 wt. %, 0.5-4 wt. %, 0.5-3 wt %, 1-10 wt. %, 1-9 wt. %, 1-8 wt. %, 1-7 wt. %, 1-6 wt. %, 1-5 wt. %, 1-4 wt. %, 1-3 wt %, 1-2 wt. %, 2-10 wt. %, 2-9 wt. %, 2-8 wt. %, 2-7 wt. %, 2-6 wt. %, 2-5 wt. %, 2-4 wt. %, or 2-3 wt %.

In some embodiments, component (iii) includes any of the above ceramic particles or carbon particles (or combination thereof) in admixture with epoxy-functionalized ceramic particles. In the foregoing embodiment, unfunctionalized or non-epoxy functionalized ceramic or carbon particles are in admixture with epoxy-functionalized ceramic particles. In some embodiments, the epoxy functionalization is provided by discrete epoxy-functionalized molecules (e.g., an epoxy silane or siloxane bifunctional molecule) bound to the particle surface. In other embodiments, the epoxy functionalization is provided by an epoxy-functionalized polymer bound to or coated onto the particle surface. The core (ceramic) portion of the epoxy-functionalized ceramic particles can have any of the compositions described above for the ceramic particles. In particular embodiments, the epoxy-functionalized ceramic particles contain a core portion having a ceramic oxide composition, such as any of those described earlier above, or more particularly, a silica, glass, or POSS composition. The core portion of the epoxy-functionalized ceramic particles may also have any of the particle sizes (1-100 nm) or ranges thereof provided earlier above for the ceramic particles. In other embodiments, the core portion of the epoxy-functionalized ceramic particles may have a larger size of 0.1 microns to 100 microns or any sub-range therein (e.g., 0.1-50 microns, 0.1-20 microns, 0.1-10 microns, 0.1-5 microns, 0.1-2 microns, 0.2-100 microns, 0.2-50 microns, 0.2-20 microns, 0.2-10 microns, 0.2-5 microns, 0.2-2 microns, 0.5-100 microns, 0.5-50 microns, 0.5-20 microns, 0.5-10 microns, 0.5-5 microns, 0.5-2 microns, 1-100 microns, 1-50 microns, 1-20 microns, 1-10 microns, or 1-5 microns).

The polymer blend material described herein may or may not include a component other than the components (i)-(iii) described above. For example, in some embodiments, an additional agent that favorably modifies the physical properties (e.g., tensile strength, modulus, and/or elongation) may be included. The additional modifying agent may be, for example, ether-containing polymers, Lewis acid compounds (e.g., boron-containing compounds), solvents, or plasticizers. In some embodiments, one or more such modifying agents are each independently, or in total, present in an amount of up to or less than 40, 30, 20, 15, 10, 5, 4, 3, 2, or 1 wt. % of the polymer blend. In other embodiments, one or more of the above modifying agents are excluded from the polymer blend material. In some embodiments, the polymer blend material contains no modifying agent beyond components (i)-(iii). In some embodiments, the polymer blend material contains solely components (i)-(iii).

An ether-containing polymer, if present in the polymer blend material, can be, for example, a polyalkylene oxide (i.e., polyethylene glycol) or a copolymer thereof. Some examples of polyalkylene oxides include the polyethylene oxides, polypropylene oxides, polybutylene oxides, and copolymers thereof or with ethylene, propylene, or allyl glycidyl ether. The ether-containing polymer may also be, for example, a polyvinyl cyanoethyl ether, as described in, for example, U.S. Pat. No. 2,341,553, the contents of which are herein incorporated by reference. The ether-containing polymer may also be, for example, an etherified form of PVA, such as poly (vinyl methyl ether), which may correspond to CAS No. 9003-09-2. The ether-containing polymer may also be, for example, a phenyl ether polymer, which may be a polyphenyl ether (PPE) or polyphenylene oxide (PPO). The ether-containing polymer may also include cyclic ether groups, such as epoxide or glycidyl groups, or as further described in, for example, U.S. Pat. No. 4,260,702, the contents of which are herein incorporated by reference. The cyclic ether polymer may also be a cyclic anhydride modified polyvinyl acetal, as further described in U.S. Pat. No. 6,555,617, or a cyclic or spirocyclic polyacetal ether, as further described in, for example, A. G. Pemba, et al., Polym. Chem., 5, 3214-3221 (2014), the contents of which are herein incorporated by reference. In yet other embodiments, the ether-containing polymer may be a cyclic or non-cyclic thioether-containing polymer, such as a polyphenyl thioether or polyphenylene sulfide. In some embodiments, any one or more classes or specific types of the foregoing ether-containing polymers are excluded from the polymer blend.

A Lewis acid compound, if present in the polymer blend material, can be any of the compounds known in the art having Lewis acid character, i.e., strongly electrophilic by virtue of a deficiency of electrons, other than any Lewis compounds (e.g., halides, oxides, carboxylates, sulfates, or nitrates of Group 13 elements) described above. Some examples of Lewis acid compounds that may be included in the polymer blend include boron-containing compounds (e.g., boric acid and boranes), aluminum-containing compounds (e.g., aluminum hydroxide), and tin-containing compounds (e.g., stannic acid and tin (IV) ethoxide). In some embodiments, any one or more classes or specific types of the foregoing Lewis acid compounds are excluded from the polymer blend.

A halogen-containing polymer, if present in the polymer blend material, can be any of the known halogen-containing polymers. The halogen-containing polymer typically contains halogen atoms bound to aliphatic (i.e., non-aromatic, e.g., alkyl or alkenyl) or aromatic groups. The halogen atoms can be, for example, fluorine, chlorine, and bromine atoms. Some examples of fluorinated polymers include poly(vinyl fluoride), poly(vinylidene fluoride), poly(tetrafluoroethylene), fluorinated ethylene-propylene copolymer, poly(ethylenetetrafluoroethylene), poly(perfluorosulfonic acid), and fluoroelastomers. Some examples of chlorinated polymers include poly(vinyl chloride), polyvinylidene chloride, ethylene-chlorotrifluoroethylene copolymer, polychloroprene, halogenated butyl rubbers, chlorinated polyethylene, chlorosulfonated polyethylene, chlorinated polypropylene, chlorinated ethylene-propylene copolymer, and chlorinated polyvinyl chloride. Some examples of brominated polymers include poly(vinyl bromide), and brominated flame retardants known in the art, such as brominated epoxy, poly(brominated acrylate), brominated polycarbonate, and brominated polyols.

In some embodiments, the polymer blend material further includes a polyacrylonitrile-containing (PAN-containing) polymer blended with components (i), (ii), and (iii), wherein the PAN-containing polymer can be referred to as component (iv). In specific embodiments, the PAN-containing polymer is a homopolymer (which contains 100 mol % nitrile content) or a copolymer of acrylonitrile with at least 50, 60, 70, 75, 80, 85, or 90 mole % nitrile content or a nitrile content within a range bounded by any two of the foregoing values or within a range having any of the foregoing values as a minimum value and a maximum value of less than 100 mol % (e.g., 95 or 97 mol %). The PAN-containing polymer is typically other than NBR. Some examples of PAN-containing polymers include styrene-acrylonitrile (SAN) polymers, acrylate-acrylonitrile types of polymers, styrene-acrylate-acrylonitrile types of polymers, and acrylonitrile-vinyl acetate polymers, wherein the acrylate portion may be, for example, methyl acrylate, acrylic acid, methyl methacrylate, methacrylic acid, itaconic acid, or a combination of any two or more of these. The PAN-containing polymer may or may not also be ABS, which typically has 15 to 35% acrylonitrile, 5-30% butadiene, and 40-60% styrene. In some embodiments, ABS is excluded from the PAN-containing polymer or ABS is excluded from the polymer blend material altogether.

In the event that one or more other components (e.g., ether-containing polymers, Lewis acid compounds, solvents, and/or plasticizers) is/are included along with the PAN-containing polymer, these additional components may be referred to as components (iv-a), (iv-b), (iv-c), and (iv-d), etc., respectively). Otherwise, if only the PAN-containing polymer or only one of the foregoing additional components is included without the PAN-containing polymer, the additional component may be referred to as component (iv). In embodiments, an advantage of including the PAN-containing polymer in the polymer blend material is that it results in a blend material with an increased nitrile content that cannot normally be achieved by the nitrile butadiene rubber component. By incorporating a PAN-containing polymer in the blend, an acrylonitrile content significantly greater than 50 mol % (e.g., at least or above 52%, 55%, 60%, 65%, or 70%) can be achieved.

In some embodiments, a metal salt is included in the polymer blend. In other embodiments, a metal salt is excluded from the polymer blend. The metal salt may contain, for example, monovalent, divalent, or trivalent metal ions, and these may be in association with one or more of the known anions, such as halides (e.g., fluoride, chloride, or bromide), carboxylates, sulfates, or nitrates. In some embodiments, the metal salt being included or excluded is a metal halide, or a specific type of metal halide, such as a divalent metal halide or trivalent metal halide, or alkaline earth metal halide, or main group metal (divalent or trivalent) halide, or transition metal (divalent or trivalent) halide. In yet other embodiments, monovalent (e.g., alkali) metal salts, tetravalent metal salts, pentavalent metal salts, or hexavalent metal salts may be included or excluded from the polymer blend material.

The polymer blend material preferably possesses a tensile strength (or “yield stress,” “tensile stress,” or “tensile yield strength”) of at least or above 5 MPa. In different embodiments, the tensile yield stress is at least or above 5 MPa, 8 MPa, 10 MPa, 12 MPa, 15 MPa, 20 MPa, 25 MPa, or 30 MPa, or a yield stress within a range bounded by any two of the foregoing exemplary values. As understood in the art, the term “tensile yield strength” or “yield stress” refers to the stress maxima in the stress-strain curve experienced by the polymer during tensile deformation just after the linear elastic region; polymers deformed beyond the yield stress usually show permanent deformation. Beyond the “tensile yield stress” point in the stress-strain profile of the polymer, the stress experienced by the polymer during stretching may remain less than that of the yield stress. Thus, “tensile strength” that is defined at the stress experienced by polymer at fracture or failure point can be lower than the yield strength. In some polymers, the tensile stress experienced at failure is significantly higher than that of the yield stress. In such cases, the stress-strain curve shows a rise (sometimes steep rise) in stress with increase in strain due to enhanced molecular orientation along the direction of deformation. Such a phenomenon of increase in the stress at large strain values (as the polymer molecules orient) is known as “strain hardening”.

For some of the exemplary yield stress values provided above, the tensile strength (i.e., the tensile stress experienced at failure, i.e., “tensile failure strength” or “ultimate tensile strength”) of the polymer blend will be higher according to the known difference in how yield stress and tensile failure strength are defined. The polymer blend material preferably possesses a tensile failure strength of at least or above 10 MPa. In different embodiments, the polymer blend material may exhibit a tensile failure strength of at least or above, for example, 10 MPa, 12 MPa, 15 MPa, 20 MPa, 25 MPa, 30 MPa, 35 MPa, 40 MPa, 45 MPa, or 50 MPa, or a tensile failure strength within a range bounded by any two of the foregoing exemplary values. In some embodiments, the polymer blend does not exhibit strain hardening; it fails at a stress below the yield stress while stretching. Any of the above tensile yield strengths can be exhibited while at an elongation or strain of at least or above 0.1%, 0.2%, 0.5%, 1, 10%, 20%, or 50%. The strain corresponding to the yield stress is called “yield strain”. In other embodiments, the polymer blend material does not show a prominent yield stress.

The polymer blend material preferably possesses an ultimate elongation (i.e., elongation at break) of at least or above the yield strain. In some embodiments, the polymer blend material possesses an ultimate elongation of at least or above 20%. In different embodiments, the polymer blend material may exhibit an ultimate elongation of at least or above 20%, 50%, 100%, 110%, 120%, 150%, 180%, 200%, 250%, 300%, 350%, 400%, 450%, or 500%, or an ultimate elongation within a range bounded by any two of the foregoing exemplary values. In some embodiments, the polymer blend material possesses any of the above preferable elongation characteristics along with any of the preferable yield stress or tensile strength characteristics, also provided above.

In some embodiments, the polymer blend material exhibits a tensile stress or tensile failure strength of at least or above 5 MPa or 10 MPa at 1% elongation. In other embodiments, the polymer blend material exhibits a tensile stress or tensile failure strength of at least or above 5 MPa or 10 MPa at 10% elongation. In some embodiments, the tensile stress at 10% elongation is at least or above 10 MPa. In specific embodiments, the tensile stress at 50% elongation is at least or above 5 MPa, 10 MPa, 15 MPa, 20 MPa, 30 MPa, 40 MPa, or 50 MPa. In some embodiments, the tensile stress at 100% elongation is at least or above 5 MPa, 10 MPa, 15 MPa, 20 MPa, 30 MPa, or 50 MPa. A conventional cross-linked (also known as vulcanized) NBR matrix containing 50 parts per hundred resin lignin may exhibit a tensile strength of only 1.5 MPa, a tensile stress at 100% elongation of 1.3 MPa, and 250% ultimate elongation, and likely no yield stress (Setua D K, et al., POLYMER COMPOSITES, Vol. 21, No. 6, 988-995, 2000).

In particular embodiments, the polymer blend material possesses a yield stress or tensile failure strength of at least or above 10 MPa, 15 MPa, 20 MPa, 25 MPa, 30 MPa, 40 MPa, or 50 MPa along with an ultimate elongation of at least or above 20%, 30%, 40%, 50%, 100%, 150%, 180%, 200%, 250%, or 300%. Moreover, in some embodiments, the polymer blend material exhibits strain hardening during mechanical deformation, such as during stretching beyond yield strain to ultimate failure.

In another aspect, the present disclosure is directed to methods for producing the polymer blend material described above. In the method, at least (or only) the components (i), (ii), and (iii) are mixed and homogeneously blended to form the polymer blend material. Any of the relative amounts by weight of components (i), (ii), and (iii), as described above, can be used in the process to result in a polymer blend containing the same relative amounts of components. Any one of the components, except for component (iii), can be included in liquid form (if applicable), in solution form, or in particulate or granular form. In the case of components (i) and/or (ii) being in particle form, the particles can have any of the particle sizes described earlier above. Typically, if any polymeric component is provided in particle or granular form, the particles are melted or softened by appropriate heating to permit homogeneous blending and uniform dispersion of the components. The components can be homogeneously blended by any of the methodologies known in the art for achieving homogeneous blends of solid, semi-solid, gel, paste, or liquid mixtures. Some examples of applicable blending processes include simple or high-speed mixing, compounding, extrusion, or ball mixing, all of which are well-known in the art. In some embodiments, the NBR polymer is in solid bale form, which can be cut into useable chunks using standard bale cutting tools. Chunks of different sizes can be mixed or blended with other component(s) in an internal mixer (such as Banbury mixer). In other embodiments, the NBR polymer is in latex form and is mixed or blended with component(s) in a ball mill. In other embodiments, the NBR polymer is in sheet form and the components are mixed in a two-roll mill.

By being “homogeneously blended” is meant that, in the macroscale (e.g., 1 millimeter or above), no discernible regions of at least components (i), (ii), and (iii) exist. If an additional component, as discussed above, is included, all or a portion of the additional component may or may not remain in the solid (unmelted) phase, e.g., either in elemental state (e.g., carbon particles) or in crystalline lamella phase (e.g., polyethylene oxide). In other words, the homogeneous blend may possess a modified or compatibilized phase structure (not necessarily a single phase structure, but often with retained but shifted T_{g} associated with individual phases) for at least components (i) and (ii). The modified-phase structure generally indicates near homogeneous integration at microscale or near the molecular level without losing each component's identity. In the case of an additional non-homogeneous component, the instantly described polymer blend including components (i), (ii), and (iii) can be viewed as a “homogeneous matrix” in which the additional non-homogeneous component is incorporated. Preferably, all of the components retain their identity and components are well dispersed at the nanometer scale.

In some embodiments, the mixture being blended further includes a crosslinking (or curing) agent, which may be a radical or physical crosslinking agent. A particular example of a physical crosslinking or curing agent is sulfur. The radical crosslinking agent is any substance that produces radicals to effect crosslinking of component (i) and/or (ii) either during the blending process and/or subsequently during a conditioning process, activation process, curing process, and/or shape-forming process. The radical crosslinking agent may decompose under thermal or radiative exposure to form reactive radicals. The radical crosslinking agent may be, for example, any of the radical polymerization initiators known in the art. In particular embodiments, the radical crosslinking agent is an organic peroxide compound. Some examples of organic peroxide compounds include dicumyl peroxide (DCP), t-butyl peroxide, benzoyl peroxide, methyl ethyl ketone peroxide, and acetone peroxide. The radical crosslinking agent may alternatively be an inorganic peroxide compound, such as a peroxydisulfate salt. The radical crosslinking agent may or may not also be selected from non-peroxide radical-producing compounds, such as azo compounds (e.g., AIBN or ABCN), or a halogen (e.g., Br₂ or I₂). In some embodiments, radical crosslinking may be achieved by physical means, such as by exposure of the material to electron beam (e.g., Stelescu et al., The Scientific World Journal, 684047, 2014) or ultraviolet (UV) radiation (e.g., Naskar et al., Carbon, 43 (5) 1065-1072, 2005) that generates free radicals for crosslinking of the components. Hydrocarbon polymers generate free radicals by exposure to electron beam radiation. In some embodiments, to facilitate UV crosslinking, the polymer blend may be further modified with acrylates and/or conjugated ketones (benzophenone derivatives) additives that generate free radicals when exposed to UV radiation. In other embodiments, any one or more specific types or general class of crosslinking or curing agents are excluded from the preparation process.

The process for preparing the polymer blend material can employ any of the weight percentages (i.e., wt. %) of components provided in the above earlier description of the polymer blend material. Moreover, during the process (i.e., during blending), certain ranges in processing temperature (i.e., during blending), shear rate, and processing time (i.e., duration of blending at a particular temperature) have been found to be particularly advantageous in producing a polymer blend material having particularly desirable physical characteristics. With respect to the processing temperature, the blending process is preferably conducted at a temperature of at least or above 80° C. and up to or less than 220° C., which may be a temperature of about, for example, 80° C., 90° C., 100° C., 110° C., 120° C., 130° C., 140° C., 150° C., 160° C., 170° C., 180° C., 190° C., 200° C., 210° C., or 220° C., or a temperature within a range bounded by any two of the foregoing values (e.g., 80-220° C., 100-200° C., 100-200° C., 140-200° C., 150-200° C., 150-190° C., or 150-180° C.). With respect to the shear rate (which is related to the mixing speed in rpm), the blending process is preferably conducted at a shear rate of at least or above 10 s⁻¹ and up to or less than 1000 s⁻¹, which may be a shear rate of about, for example, 10, 20, 30, 40, 50, 100, 150, 200, 250, 300, 350, 400, 500, 600, 700, 800, 900, or 1000 s⁻¹, or a shear rate within a range bounded by any two of the foregoing values. The mixing rate (in rpm) corresponding to the foregoing shear rate range is approximately 1-150 revolutions of the blades per minute. With respect to processing time, the blending process preferably employs a processing time (time during blending at a particular temperature and shear rate) of at least or above 5 minutes and up to or less than 120 minutes, which may be a processing time of about, for example, 5, 10, 20, 30, 40, 50, 60, 70, 80, 90, 100, 110, or 120 minutes, or a time within a range bounded by any two of the foregoing values.

The polymer blend material may be subjected to a shape-forming process to produce a desired shape of the polymer blend. The shape-forming process can include, for example, extrusion molding (e.g., pour, injection, or compression molding), resin transfer molding, melt pressing, or stamping, all of which are well known in the art. In other embodiments, the polymer blend material is used in a printing process to form a shape containing the polymer blend material, wherein the printing process can be, for example, a rapid prototyping (RP) process known in the art, such as a fused deposition modeling (FDM) or fused filament fabrication (FFF) process known in the art, which may also be collectively considered as 3D printing processes. In some embodiments, the compression molded blends are further annealed or cured at a temperature below its molding temperature for it to form equilibrium morphology. The temperature can be between T_{g} of the lignin and the molding temperature. In some blends, the annealing temperature is between 70-150° C. A convection oven can be used for annealing of initially molded blends. During annealing, the blend components undergo both stress relaxation and a crosslinking reaction. The shaped object may be used as an adhesive by placing it between adherent surfaces before being subjected to a thermal pressing process, as described in further detail below.

In another aspect, the present disclosure is directed to a method of bonding (adhering) first and second surfaces together by use of any of the above-described polymer blend adhesive compositions. For example, the polymer blend composition may have any of the filler compositions described above, such as any of the ceramic and/or carbon particle compositions described above, and may or may not have any one or more additional components described above. In the method, the self-healing adhesive composition is placed (applied) between the first and second adherent surfaces and the surfaces are hot pressed at a temperature of 80° C. to 200° C. In different embodiments, the applied temperature may be precisely or about, for example, 80° C., 90° C., 100° C., 120° C., 150° C., 180° C., or 200° C., or a temperature within a range bounded by any two of the foregoing values (e.g., 80-180° C., 80-150° C., 80-120° C., 100-180° C., 100-150° C., or 100-120° C.). The first and second surfaces may be the same or different and may be selected from, for example, metal surfaces (e.g., steel or aluminum), ceramic surfaces (e.g., cement, concrete, cinder block, or brick), glass surfaces, polymer matrix composite surfaces (e.g., carbon fiber composites), construction materials containing gypsum (e.g., wall board, dry wall, sheet rock, plasterboard), wood, plastic, or any combination of such surfaces. The method may also include a subsequent step of reheating the bonded (adhered) surfaces to soften the polymer blend adhesive for the purpose of repairing defects in the adhesive, or for the purpose of removing the adhesive to re-use or recycle it.

In still other aspects, the invention is directed to an article containing the polymer blend described above. The article is typically one in which some degree of toughness is desired along with high mechanical strength. The blend may or may not be further reinforced with, for example, continuous carbon, or metallic fibers to produce composite parts. The article may be used as or included in any useful component, such as a structural support, the interior or exterior of an automobile, furniture, a tool or utensil, or a high strength sheet or plate. In some embodiments, the polymer blend may be produced and applied as a coating or film, such as a protective or adhesive film. The polymer blend may be rendered as a coating or film by, for example, melting the blend or dissolving the components of the blend in a suitable solvent, followed by application of the liquid onto a suitable substrate and then solvent removal.

Examples have been set forth below for the purpose of illustration and to describe certain specific embodiments of the invention. However, the scope of this invention is not to be in any way limited by the examples set forth herein.

### Example 1

### Adhesive Preparation

The ABL-based adhesives studied herein were prepared through a Brabender internal mixer. Nitrile butadiene rubber (NBR) containing 51% nitrile (i.e., “NBR-51”), along with 60 wt. % lignin, were shear-mixed in an internal mixer under 160° C. and 90 rpm for 3 minutes, then various amounts of fumed silica (FS) (2 wt. %, 5 wt. %, 7 wt. %, 10 wt. %) were added into the chamber, and the mixing process continued for 35 minutes. The produced compounds were labeled as ABL-FS. Selective amounts of epoxidized glass spheres (EGS) (at 5 wt. %, 15 wt. %, 30 wt. %, and 45 wt. %) were transferred into the chamber after initial shear mixing of ABL and FS for 3 minutes and the mixing continued for 35 minutes to produce ABL-FS-EGS composite adhesives. For the control ABL sample, NBR-51 and 60 wt. % lignin were shear-mixed under the same temperature and rotation speed for 35 minutes. To further enhance the nitrile content of NBR rubber, varying amounts of polyacrylonitrile polymer (PAN) (0.5, 1, 2, 5, and 7 parts per hundred parts of NBR) were pre-melt-blended with NBR at 160° C. for 10 minutes. The modified NBR served as the new rubber matrix for preparing the ABL-FS-EGS adhesive, which was labeled as ABL-PAN. Neat ABL and its reinforced composites were pressed into films by placing the material between two 254×254 mm² metal plates covered with Teflon films using a carver press at 180° C., 90 kN for 15 minutes. To control the thickness of produced film (0.35 mm), a frame shim was placed between the plates.

### Single-Lap Shear (SLS) Test Sample Preparation

The aluminum adherent (Al 6061) was polished with 320 grit sandpaper and sonicated in acetone at room temperature for 15 minutes before use. The above-prepared adhesive films were cut into 12.7×25.4 mm² rectangular shapes and placed between two Al bars. Five duplicates were pressed at 180° C. and a pressure of 55 MPa for 25 minutes to obtain the bonded samples. A spacer was used to control the adhesive layer thickness (0.25 mm). Other adherent such as aluminum 7075, dual phase 980 steel, carbon fiber reinforced composites were also used as adherent.

### Adhesive Characterization

The adhesive films were cut into Type V dog bones and the tensile properties were tested with a commercial testing system based on the ASTM D638. The testing speed was 50 mm min⁻¹, and the displacement was recorded using an MTS long travel extensometer. The lap shear strength (LSS) was tested using the same testing system based on the ASTM D3165 with a speed of 1.27 mm min-1, and sets of five specimens were tested for each type of adhesive.

Fourier Transform Infrared (FTIR) spectra of the adhesives were collected in attenuated total reflection (ATR) mode using 128 scans with 4 cm⁻¹ resolution to analyze each adhesive film. Baseline correction was applied. The absorbance of the peak corresponding to the CN band observed at 2238 cm⁻¹ was used to normalize the spectra.

Surface free energy was measured based on the Owens, Wendt, Rabel, and Kaelble (OWRK) method (D. H. Kaelble. J. Adhes. 1970; 1; 2 (2): 66-81. doi: 10.1080/0021846708544582; W. Rabel. Farbe und Lack. 1971; 77 (10): 997-1005; D. K. Owens et al., J. Appl. Polym. Sci. 1969; 13 (8): 1741-7. doi: 10.1002/app.1969.070130815). The contact angles on the sample surfaces were recorded using a surface energy analyzer with two kind of liquids (water and diiodomethane). Each sample was measured five times to obtain the average value. A detailed discussion of the process is provided in Y. Shin et al., Compos Part B—Eng 2022; 240:110001.doi: 10.1016/j.compositesb.2022.110001.

The dynamic mechanical properties of the adhesive were analyzed with a commercial dynamic mechanical analyzer for solids. The storage modulus (G′) and loss modulus (G″) were recorded in the temperature range from −50 to 200° C. with a temperature increasing step of 3° C. min⁻¹ and 1 Hz frequency. The mechanical damping factor tan & was calculated as the ratio of G″ and G′.

The rheological properties of the adhesives were investigated using a commercial rheometer. The linear region of G′ was determined by frequency sweep from 100 to 0.1 rad s⁻¹ with a 1% strain amplitude. The rheological properties were then analyzed using strain sweep with an angular speed of 100 rad s⁻¹ at 160° C. The axial force was set as 1N for the tests with a sensitivity of 0.5N.

The cryogenically fractured surfaces of the ABL-based adhesive surfaces were investigated with a scanning electron microscope (SEM). All of the images were collected at a working distance of 10 mm and with an accelerating voltage of 10 kV.

### Representative Volume Element (RVE) Modeling

To investigate the underlying mechanisms responsible for the reinforcement provided by the fillers and utilize this knowledge to advance the development of ABL-based adhesives, a computational framework based on a representative volume element (RVE) was developed for these composites. The RVE offers a means of addressing heterogeneous materials with homogenous macroscopic structures at a continuum length scale. As well known, RVE is a small volume of material that is statistically representative of the entire composite. In the present situation, the ABL-based composites can be simplified as a series of regular microstructures that make up the RVE. By subjecting these RVEs to various loads with relevant boundary conditions and examining their stress-strain behavior through finite element (FE) modeling, the mechanical properties of the composites were investigated.

### Results and Discussion

### Adhesion of ABL-Based Adhesive

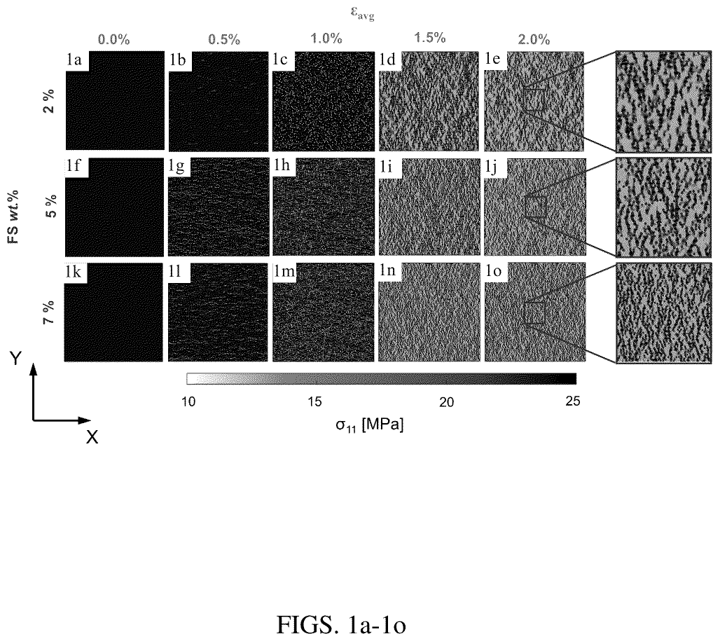

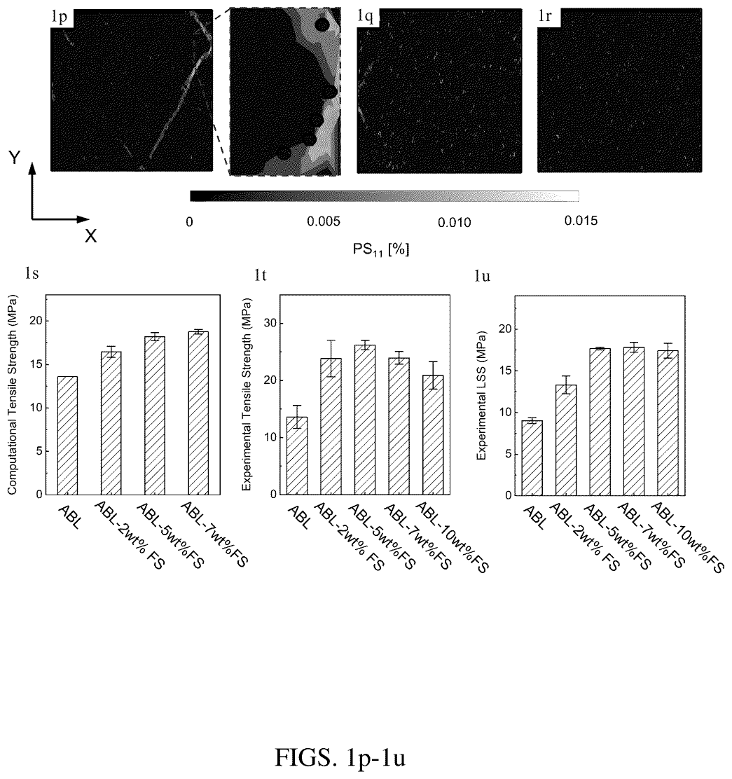

The RVE analysis was used to investigate the mechanism by which integrating FS nanoparticles into the ABL matrix strengthens its overall mechanical properties through a reinforcing mechanism. However, it was herein found that it is not feasible to generate RVE models with higher weight percentages of nanoparticles beyond 7 wt. %, due to the jamming effect (S. Kari et al., Compos Struct 2007; 77 (2): 223-231.doi: 10.1016/j.compstruct.2005.07.003). For this reason, FIGS. 1a-1u include the simulated properties of an ABL-FS composite with FS loading up to 7 wt. %. FIGS. 1a-1o show the spatial distribution of X-component stress (σ₁₁) within the RVEs with different wt. % of FS at varying ε_{avg} (the average tensile strain in X direction). As the magnitude of ε_{avg} increases from 0% to 2%, there is a gradual increase in induced stresses within the composites. In these plots, it was observed that the stress distributions were non-uniform. The particles experienced high-stress levels, while the ABL matrix underwent less stressed, as observed in zoomed-in stress distribution maps (FIGS. 1e, 1j, and 1o, insets). This result is reasonable, as the highly stiff FS nanoparticles (E_{FS}≈135×E_{ABL}) function as reinforcements and bear most of the stresses within the composites, thereby protecting the ABL matrix from damage.

The ABL-FS peak stresses were characterized from the computational study. It was herein found that 2, 5, and 7 wt. % FS nanoparticle-based composites have peak stress equal to ˜16, ˜17, and ˜17.5 MPa, respectively (FIG. 1s). The maps of plastic strain in the X direction (PS₁₁) corresponding to the peak stress (FIGS. 1p-1r) reveal the buildup of plastic deformation inside the RVEs. It was observed that a continuous band formed within the PS₁₁ maps of the 2 wt. % composites (FIG. 1p), indicating a global failure of the RVE. On the other hand, accumulations of PSn were discrete in the case of 5 and 7 wt. % composites (FIGS. 1q and 1r, respectively) suggesting the overall strengthening of the composites via FS reinforcement. It can thus be hypothesized that stiff FS nanoparticles within the ABL offer a more torturous pathway towards a continuous failure surface formation. Upon zooming in on the PS₁₁ plot of 2 wt. % composites (FIG. 1p, inset), it was found that the deflection of the failure plane from the location of the microparticles validates the current hypothesis. Despite the limitations of the proposed RVE modeling technique, this computational study demonstrates that the inclusion of FS nanoparticles in ABL can improve its mechanical properties, which could enhance the adhesion properties of ABL.

Based on the computational data, the mechanical properties of ABL-FS with 2 wt. %, 5 wt. %, and 7 wt. % FS were selected for investigation. An ABL composite with 10 wt. % FS was also prepared to explore the performance of the composite beyond the computational limit. The experimental tensile strength and adhesion of all the ABL-based adhesives were tested and used to compared with the simulated results, which are shown in FIGS. 1t and 1u. With the incorporation of 2 wt. %, 5 wt. %, 7 wt. %, and 10 wt. % FS into the ABL matrix, the tensile strength of composite adhesives was increased by 75%, 93%, 76%, and 54%, respectively. Besides being used as reinforcing fillers, the FS also functions as a thickening agent that additionally modifies the rheological properties of the composites during the melt shear-mixing process. This helps the separation and dispersion of the lignin phase, which leads to an improved tensile strength.

With the addition of FS, the size of the lignin domains decreased, and a more uniform dispersion condition of lignin was achieved. However, after 5 wt. % loading, continuously increasing the loading of FS led to a drop in tensile strength, which was likely caused by particle aggregation and insufficient dispersion at high nanoparticle contents. The improved mechanical properties of the adhesive itself had a beneficial effect on the LSS. As shown in FIG. 1u, compared to the 9.0 MPa of LSS for the control sample, the adhesives with FS obtained values of 13.3 MPa, 17.7 MPa, 17.8 MPa, and 17.4 MPa for 2 wt. %, 5 wt. %, 7 wt. %, and 10 wt. % samples, respectively, which were 48%, 97%, 98%, and 93% higher than the control. The ABL-FS adhesive with 7 wt. % and 10 wt. % FS loading gave a similar LSS as the 5 wt. % sample, even though their tensile strengths were lower than the value of the 5 wt. % sample. A likely reason for this result is that the LSS can be affected by multiple parameters, such as adhesive tensile strength, toughness, and surface chemistry.

The toughness of the 7 wt. % and 10 wt. % FS-containing samples exhibited an 85% and 81% improvement compared to the 5 wt. % FS-containing sample. As demonstrated by the simulation results, rigid particles impede crack propagation and help improve fracture energy. This can also result in the rise of LSS for the ABL-FS adhesive. The difference between the calculated and tested results may result from the interfacial interactions and dispersion status of reinforcing fillers, which were not explicitly modeled. Perfect bonding was assumed here and the damage of ABL and ABL/particle interface was not accounted for in the modeling. Moreover, the size of the RVE is not large enough in this study to allow for the full development of energy dissipation in ABL-FS composites.

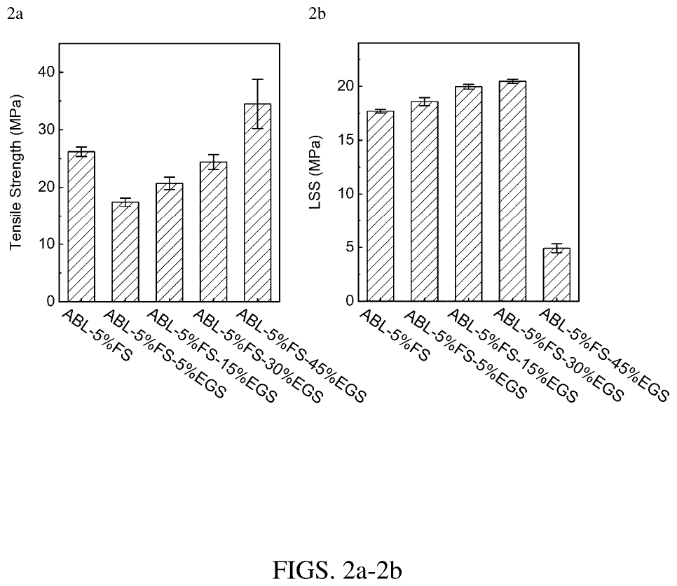

By virtue of the high stiffness of the EGS (˜86.8 GPa tensile modulus) and its available surface functionality, EGS was incorporated into the ABL-FS system to modify its mechanical properties and surface energy. The EGS were not considered in the computational study due to their larger size (˜2,500 times larger than the FS nanoparticles), which would require a larger RVE volume to accurately represent the microstructure of the ABL-FS-EGS composites. The need for a larger RVE volume to incorporate the statistically considerable number of EGS would also result in an exponential increase in the number of FS nanoparticles that must be included, making the computational study more intensive. Thus, the reinforcing effect of EGS was analyzed directly through the experimental results and summarized in FIG. 2. The LSS consistently increased with increasing loading of EGS and reached a peak of 20.5 MPa at 30 wt. %, which was 16% elevated compared to the control sample (ABL-5 wt. % FS). When the EGS content was raised to 45 wt. %, there was a sharp drop in LSS. This drop in LSS was due to a lack of sufficient ABL matrix to maintain the elasticity and adhesion of the adhesives. The effect of the EGS on tensile strength, as shown by the data in FIG. 2a, demonstrates that the EGS provided the reinforcement at relatively high loadings. The adhesives with 45 wt. % EGS exhibited a tensile strength of 34.5 MPa compared to 26.2 MPa of the control sample. However, its brittleness caused by high filler loadings led to a low LSS result, as shown by the data in FIG. 2b.

The stress-stain curves of the ABL-FS-EGS adhesive films were obtained and the toughness for these samples was calculated. It was herein found that the addition of the EGS increased the toughness by 560%, 174%, and 5% at the loading of 5 wt. %, 15 wt. % and 30 wt. %. A very high loading of micrometer-sized EGS filler is not as effective for matrix reinforcing compared to nanofillers. The improved matrix toughness provided by the filler loading can be attributed to two factors: (1) improved dispersion of fillers and lignin during mixing and (2) resistance to crack propagation of matrix caused by particulate fillers.

Notably, the micrometer-sized glass spheres (EGS) improved with milling of the ABL-FS composite, which further improved the dispersion of lignin and FS particles. From SEM images for fractured surfaces of adhesives, the ABL-FS-EGS were found to exhibit smooth surfaces with no agglomerates. The finer dispersion can better resist the crack growth (fewer defects in the matrix), which leads to higher toughness. Also, for cracks to grow, detachment of the polymer matrix from the glass spheres is necessary. Chemical bonding between spheres and the matrix resists such separation. These mechanisms contribute to the improvement of the matrix toughness. The final LSS is a result of compounded effects of both toughness and stiffness enhancement of the matrix. The improvements in the toughness contributed to the final enhancement of LSS. However, the addition of micrometer-sized stiff EGS particles into the polymer matrix led to the brittleness of the composite, causing the drop of toughness The EGS can also improve the interactions between the adhesive layer and substrate by virtue of its surface functionalities. It was herein observed that the ABL-FS-EGS composite that had the highest surface energy gave the best LSS result.

To compare the adhesion performance of the best ABL-FS-EGS adhesive with the commercial product, a commercial epoxy adhesive was used to prepare the SLS test samples following the same procedure as ABL adhesives. The bonded aluminum joints were kept at 175° C. for 25 minutes in the hydraulic carver press for full curing and the LSS was 23.4 MPa. It is intriguing that the thermoplastic ABL adhesive can reach around 90% of the performance of a commercial epoxy-based adhesive, which suggests a great potential for this newly developed adhesive in the near future.

### Surface Chemistry Analysis

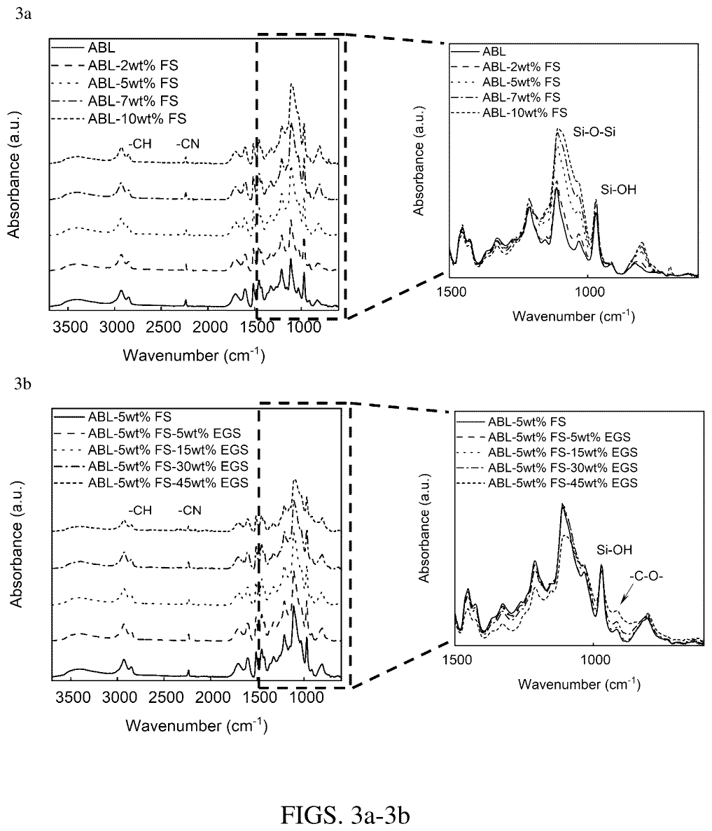

The interfacial property between the adhesive and substrate is another important factor that can affect joint strength. The polar functional groups from the reinforcing fillers can improve the interaction between the adhesive and aluminum adherent. The surface chemistry of the ABL-based adhesives was analyzed by FTIR and surface energy measurements to investigate the effect of different fillers. The FTIR results are summarized in FIGS. 3a and 3b. The data in these figures compare the ABL adhesive with different types and loadings of fillers. For the ABL-FS adhesives, shown in FIG. 3a, two sharp peaks at 2929 cm⁻¹ and 2855 cm⁻¹ belong to the C—H stretching of the —CH₂ group from the ABL matrix. The peak that at 2238 cm⁻¹ is the characteristic peak for NBR, which can be attributed to the stretching of —CN groups (S. Hait et al., Heliyon 2020; 6 (8): e04659.doi: 10.1016/j.heliyon.2020.e04659). The peaks at 1110 cm⁻¹ and 970 cm⁻¹ belong to Si—O—Si and Si—OH (S. Hait et al.). With a higher loading of FS, the intensity of these two peaks also increased. Adding additional EGS into the ABL-FS adhesive led to an intensity increase in the 910 cm⁻¹ peak (FIG. 3b), which represents the —C—O— from the epoxide group. The polar functional groups, such as Si—OH and epoxide, increase the dipole moment, which can interact with numerous polar groups and enhance the intermolecular associative force via dipole-dipole interactions. Further, the polar functional groups may form hydrogen bonds with the aluminum surface to enhance the adhesion strength. With the incorporation of FS and EGS, the total energy and polar component increased with the increased loading of fillers for most composites. Among them, the composites with a 30 wt. % content of EGS had the highest total energy, which was 10.5% higher than the control ABL-5 wt. % FS sample. The polar component also showed a 37.3% enhancement. However, continued addition of the EGS led to a drop in surface energy which may be attributed to a significant loss in the content of the ABL matrix. The same trend was also observed in the LSS results. The modified surface chemistry and improved mechanical properties combined to contribute to the better LSS results of ABL adhesives with fillers.

The fractured interfaces of all the ABL-based adhesives were studied after the lap shear tests. Even though additional functional groups were incorporated into the ABL matrix and surface energy was improved, all the samples still showed adhesive failure (failure at the interface between substrate and adhesive), which indicates that surface treatment, either on adhesive or substrate, may be applied to further improve the performance of ABL-based adhesive bonding.

### Viscoelastic Properties

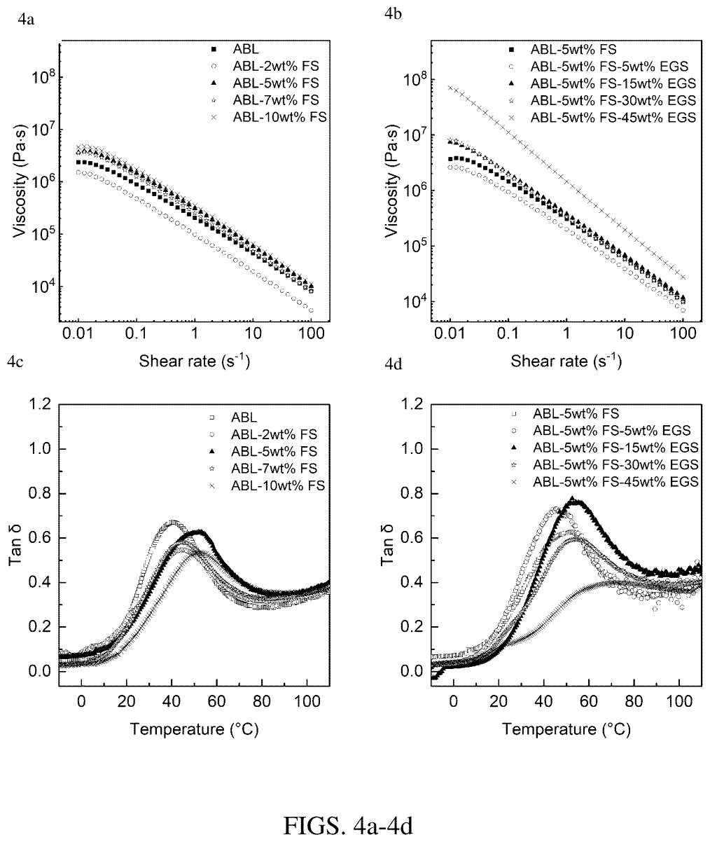

Tension, compression and shear stresses are usually introduced into metal-metal connecting parts during the joining process. Traditional uncured liquid adhesives can be squeezed out from the space between two adherents, which deteriorates the joint strength. The film adhesive developed within this work is designed to address this problem. The processability of ABL-based adhesives for joining processes was evaluated, and the viscoelastic properties are shown in FIGS. 4a-4d. Since the ABL-based adhesive were prepared at a temperature of 160° C., the rheological properties of the molten compositions were investigated at the same temperature. It may be noted that FS particles are often used as polymer matrix thickening agents. With the incorporation of FS into the ABL matrix, the increased viscosity of the composite may enhance the dispersion and shear-induced separation of the hydrogen-bonded lignin aggregates during the melt-mixing process. At low concentrations of FS, the dilution effect dominates, and modified morphology leads to a drop in viscosity and storage modulus, as shown in FIG. 4a. The glass spheres offer a weak reinforcing effect on melt rheology with a low filler concentration. At low concentration of fillers, desorbed, unentangled polymer chains from the filler surface provide a stress softening effect. This is believed to be due at least in part to the large size of the filler spheres that offer unpacked regions between the fillers and matrix materials. Continued addition of the FS into the ABL matrix, due to the large surface area of nanoparticles and the hydrogen bonds formed between the fillers and matrix, resulted in the increased viscosity and storage modulus. Because of their high specific surface area, the high structure FS fillers form aggregates which gradually disperse under an applied shear during the melt-mixing process to form three-dimensional assemblies of networks in the polymer matrix (Cassagnau et al., Polymer 2008; 49 (9): 2183-2196.doi: 10.1016/j.polymer.2007.12.035). As a result, the viscosity and dynamic mechanical properties of the ABL-FS composites may result from a combined effect of the thickening effect of nanoparticles, hydrogen bonding between fillers and matrix, and the dispersion status of additives.

FIG. 4c shows the loss tangent or tan δ spectra of all the ABL-FS-based adhesives. The damping factor tan δ is a measure of the ratio of loss to storage moduli (G″/G′) of the specimen at a given temperature. The tan δ peak position corresponds to the compositions' glass transition temperature (T_{g}). Compared to the control sample (41° C.), all of the ABL-FS samples had increased values of T_{g}, 45° C., 52° C., 45° C., and 53° C. for the 2 wt. %, 5 wt. %, 7 wt. %, and 10 wt. % FS loaded samples, respectively. The rise of T_{g} indicated a better interaction between the filler and polymer matrix, and the results agreed well with the improved tensile strength. The magnitude of the tan & peak represents the dissipation of energy attributed to the internal friction and molecular motions (H. Y. Wei et al., Compos Part B—Eng 2020; 193 (15): 108035.doi: 10.1016/j.compositesb.2020.108035). The damping behavior is affected by the addition of FS nanoparticles, due to the immobilization or confinement of NBR polymer chains by nanofillers. When the FS loading was higher than 2 wt. %, the height of tan & peak decreased along with the increase of filler content, which indicated the enhanced elastic properties of ABL-FS composites. This is important for certain hybrid metal joining processes, such as riveting of adhesively bonded components, to preserve the adhesive between the substrates. For such hybrid joint fabrication with this thermoplastic adhesive, pre-heating the adhesive film above the T_{g} is helpful, which can decrease the brittleness and improve the processability. Also, specific metal joining method, such as high velocity riveting or high-rate friction riveting, can bring in friction-caused additional heat that will further soften the adhesive material. To avoid the adhesive ‘squeeze-out’ during high-speed riveting, the viscosity and elastic properties of an adhesive are important, especially at temperatures above the T_{g}.

The incorporation of FS nanoparticles improved the dispersion of lignin particles, and their surface hydroxyl groups were beneficial for higher interfacial adhesion with polymer chains or lignin particles. The higher storage modulus and reduced mobility of polymer segments near the interface of the ABL-FS adhesive favor hybrid joints. Because of the stiffness of the EGS (estimated as ˜86.8 GPa tensile modulus) and the surface functional groups, it was used to enhance the mechanical properties and surface energy of ABL-based adhesives. As shown in FIG. 4b, the introduction of EGS led to an increase of both storage modulus and viscosity. However, as reflected in FIG. 4b, all of the adhesives still possessed the shear thinning effect, which is beneficial for processing.

FIG. 4d summarizes the tan & profile for all the ABL-FS-EGS-based adhesives. The epoxy groups on the glass sphere surfaces are beneficial for the interfacial interaction between the fillers and ABL-FS matrix. By incorporation of stiff EGS, the T_{g} was increased by 2° C., 3° C., and 20° C. with a 15 wt. %, 30 wt. %, and 45 wt. % filler loadings, respectively. However, the composite with 5 wt. % EGS showed a 6° C. decrease of T_{g} and its storage modulus was also lower than the control sample. This indicates that at low volume fraction, EGS has a softening effect. The desorbed or unbound, unentangled polymer chains around filler surface show stress softening effect. The existence of voids between the large filler particles and polymer matrix (as observed), indicates a weaker interface at low EGS loading. With further addition of EGS, the matrix stiffening effect increases due to increased volume fraction of immobilized polymer chain on the filler surface. Nonetheless, a clear contrast in the storage moduli of 15 wt. % or higher filler filled ABL compared to the control unfilled ABL was observed. As the concentration of EGS in the composites grew, the mobility of the polymer chains became further restricted by the fillers. Because of this interaction, ABL with higher EGS content behaved more like an elastic solid, resulting in a higher storage modulus.

### Recyclability and Anti-Aging Properties

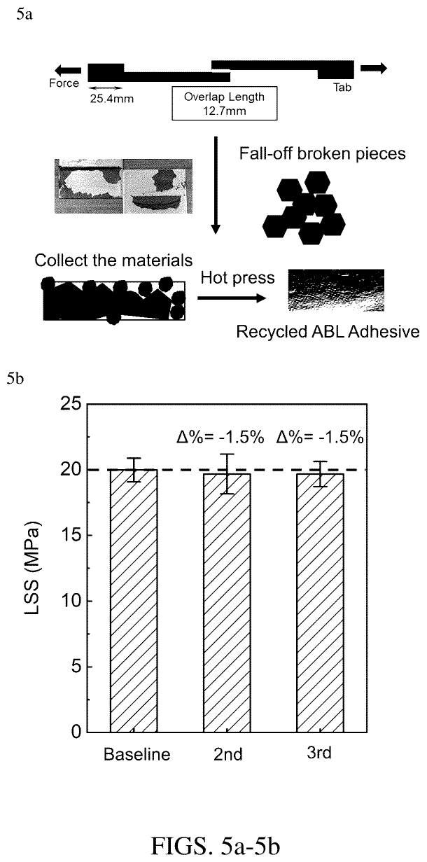

Unlike traditional thermoset adhesives, which create joints that cannot be disassembled once cured, the ABL-5 wt % FS-20 wt % EGS composite film, a representative ABL-FS-EGS thermoplastic adhesive, can be reused via collection and reprocessing for next joining cycle. The schematic illustration of the testing and recycling process is summarized in FIG. 5a. Initially, Al-ABL adhesive-Al joints were tested to establish a baseline LSS. Subsequently, both the detached broken adhesive pieces and the remnants on the substrates were collected. Combining these with 10 wt. % of raw materials (to compensate for material loss during testing), the mixture was re-pressed to form a second-generation ABL adhesive. This reprocessed adhesive film was then used to create new Al-ABL adhesive-Al joints following the same procedure as the initial bonding. This testing and reprocessing cycle was repeated a third time to evaluate the recyclability of the adhesive. The LSS results are presented in FIG. 5b. Compared to the baseline sample, both the second and third generation ABL adhesives maintained equivalent adhesion strength, with a negligible 1.5% drop in LSS falling within statistical errors, thus demonstrating the effective recyclability of this sustainable thermoplastic adhesive. Strengthening the interaction between the adhesive and substrate not only enhances adhesion performance but also ensures that the adhesive remains attached to the substrate surface, which can simplify the re-joining process, thus permitting debonded Al substrates to be directly hot-pressed to form new joints. This approach can facilitate the maintenance and repair of the joints without deteriorating their performance.

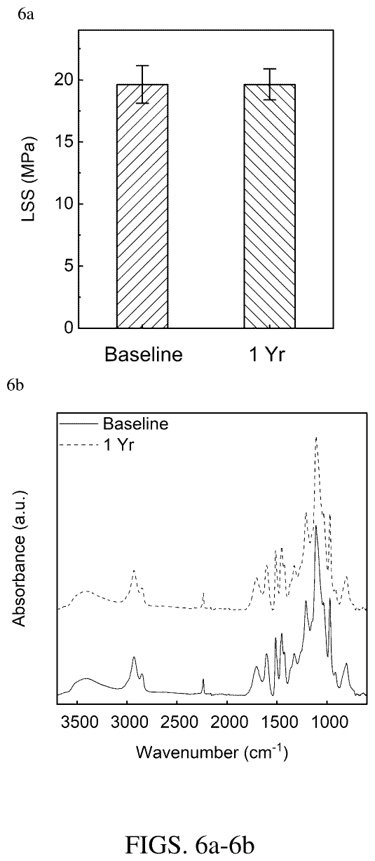

Moreover, lignin, with its abundant phenolic hydroxyl groups, can slow the aging process of rubber by capturing active radicals that are produced during the aging process. More specifically, hardwood lignin acts like hindered phenol with high radical scavenger activity without compromising its melt-processibility. This characteristic helps prevent the oxidation chain reaction, thereby enhancing the anti-aging properties of rubber composites. To test this, both the newly prepared ABL adhesive and the adhesive stored under ambient conditions for one year were used to prepare the SJS samples. The LSS results are summarized in FIG. 6a. The ABL adhesive exhibits consistent adhesion strength, attributed to the anti-aging effect of the lignin particles. The FTIR results (FIG. 6b) further confirm the stability of the ABL adhesive, as the peak intensity remains unchanged after one year.

### Dissimilar Substrate Joining Performance

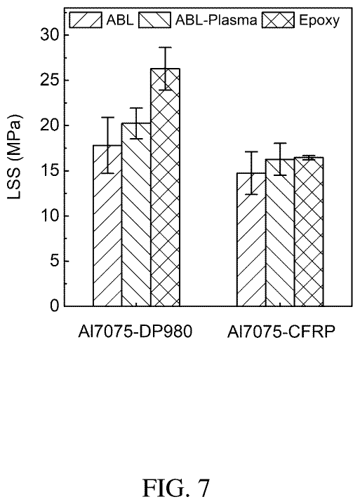

Joints containing dissimilar substrates were prepared using the procedure outlined above. The LSS is summarized in FIG. 7. Plasma treatment of the adhesive film provided an additional 10-15% improvement in LSS, enabling the ABL adhesive to achieve approximately 80% of the performance of commercial epoxy adhesive with aluminum-steel (A17075-DP980) joints, or nearly identical adhesion strength with aluminum-carbon fiber composite (A17075-CFRP) joints.

### Modification of NBR Polarity Via Additional PAN Loading Prior to Compounding of ABL and ABL-FS-EGS Adhesive Fabrication

The synthesized PAN powder (manufactured in laboratory with ˜70 kg/mol molecular weight) was incorporated into the ABL adhesive to enhance the mole fraction of nitrile groups in NBR rubber. Subsequently, ABL-FS-EGS adhesive was prepared by the melt mixing method discussed earlier. In one such composition, dicumyl peroxide (DCP) was used as the curing agent to initiate a degree of crosslinking within the ABL matrix between the unsaturated bonds in the NBR backbone. Specifically, ABL-5 wt % FS-20 wt % EGS adhesive composition mixed at 160° C. was also compounded with 0.5 parts per hundred parts of NBR rubber which was premixed with 5 parts of PAN powder per hundred parts of NBR. The low dosage of peroxide enabled partial crosslinking of rubber without compromising its melt processability. Furthermore, as lignin is a free radical scavenger, it reduces the degree of crosslinking. The partially cured molded thermoplastic rubbery ABL-FS-EGS adhesive was compared with other ABL compositions on their performance in joining two Al 6061 adherents.

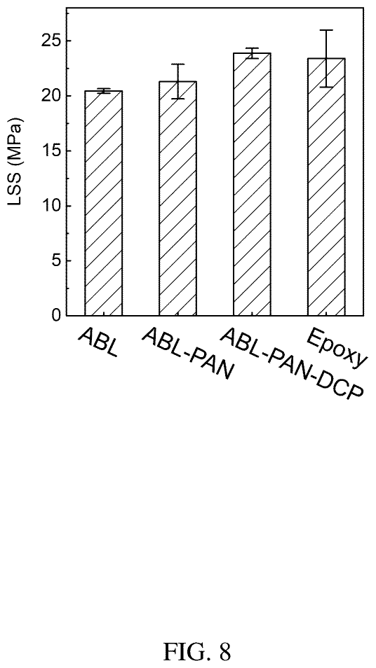

The LSS results are shown in FIG. 8. The optimally modified ABL adhesive achieved a value of 23.9 MPa, exceeding the average adhesion strength of commercial epoxy adhesives, and the standard deviation was reduced by 82%. A thermoplastic recyclable adhesive composition consisting of sustainable ingredients such as lignin was realized, and it outperformed an existing thermoset adhesive.

The sequence of DCP loading to prepare partially cured ABL-FS-EGS adhesive did not alter the LSS significantly. To test the effects of partial crosslinking of NBR phase by use of peroxide versus the effects of crosslinking of lignin phase, an ABL-based inverse thermoplastic vulcanizate composition was used. In this inverse thermoplastic vulcanizate, the lignin phase was crosslinked with di- or tri-acid chlorides as reported earlier (Kanbargi, N., et al. (2021). Synthesis of High-Performance Lignin-Based Inverse Thermoplastic Vulcanizates with Tailored Morphology and Properties. ACS Applied Polymer Materials, 3 (6), 2911-2920). Although the ABL-based inverse thermoplastic vulcanizate displayed sufficient strength and stiffness, it failed to deliver an acceptable joint for proper LSS testing. Acid chloride-based crosslinking of lignin reduced the content of the phenolic and aliphatic hydroxyl groups in the ABL formulation, and this reduction in polarity or hydrogen-bonding capacity likely lowered the adhesive performance.

### CONCLUSIONS

Sustainable, toughened thermoplastic ABL-based adhesives were herein developed and characterized. The FS and EGS particulate fillers were used as reinforcing fillers to further improve the LSS values for the ABL-based adhesives because of their good mechanical properties, thickening effect, and surface energies. Various amounts of FS were first incorporated into the ABL matrix to modify the mechanical and viscoelastic properties, as well as the surface chemistry of the adhesives. Because of the large surface area and hydrogen bonding formed with the matrix, introducing FS increased the viscosity and storage modulus of the ABL-FS adhesive. The higher viscosity of the composites led to a larger shear force during the melt-blending process, which was beneficial for the separation and dispersion of aggregated lignin. The RVE modeling results demonstrated that the stiff FS nanoparticles in the ABL matrix create a torturous pathway for the crack propagation. As a result, the LSS obtained a ˜97% improvement with a 5 wt. % FS loading. EGS was added as an additional filler to the ABL-FS composites during a melt-shear-mixing process. Attributed to the intrinsic high stiffness (˜86.8 GPa tensile modulus) and surface functionalities of EGS, both storage modulus and viscosity were elevated with increased filler loading. The T_{g} was further imporved by 20° C. with introduction of 45 wt. % of EGS compared to the ABL-FS control sample. At an optimal 30 wt. % EGS in the ABL-FS matrix, the LSS reached 20.5 MPa, which was 16% higher than the ABL-5 wt. % FS sample and reached 90% performance of a commercial epoxy-based adhesive.

By incorporating PAN powder into NBR matrix to increase the mole fraction of nitrile content, and by using DCP to slightly enhance the degree of crosslinking within ABL adhesive, the optimal LSS surpassed the average adhesion performance of commercial epoxy adhesives for aluminum joints. The fractured interfaces confirmed that the current lap shear test failure was due to the interfacial failure, highlighting that surface treatments such as a plasma or chemical functionalization could further improve adhesion performance. Additionally, the thermoplastic ABL adhesive demonstrates excellent recyclability and anti-aging properties. This sustainable thermoplastic adhesive can be applied in the high-volume automotive body part assembly. These partly renewable adhesives may be used to replace mechanical fasteners to reduce energy consumption, simplify the manufacturing process for joining of parts, and promote sustainability in the automotive industry.

While there have been shown and described what are at present considered the preferred embodiments of the invention, those skilled in the art may make various changes and modifications which remain within the scope of the invention defined by the appended claims.

What is claimed is:

1. A polymer blend material comprising the following components:
(i) a lignin component;
(ii) a nitrile butadiene rubber component; and
(iii) a filler component comprising ceramic particles having an average primary particle size of 1-100 nm, wherein component (iii) is present in an amount of 0.1-10 wt % by weight of components (i) and (ii);
wherein component (i) is present in an amount of about 5 wt % to about 95 wt % by weight of components (i) and (ii).

2. The polymer blend material of claim 1, wherein said lignin component is a hardwood lignin, softwood lignin, organosolv lignin, or grass-derived lignin.

3. The polymer blend material of claim 1, wherein component (i) is present in an amount of about 30 wt % to about 70 wt % by weight of components (i) and (ii).

4. The polymer blend material of claim 1, wherein component (i) is present in an amount of about 40 wt % to about 60 wt % by total weight of components (i) and (ii).

5. The polymer blend material of claim 1, wherein component (ii) has an acrylonitrile content of at least or above 40 mol %.

6. The polymer blend material of claim 1, wherein component (ii) has an acrylonitrile content of at least or above 50 mol %.

7. The polymer blend material of claim 1, wherein component (i) is dispersed in component (ii) in the form of domains having a size of up to 1000 nm.

8. The polymer blend material of claim 1, wherein component (iii) is present in an amount of 1-10 wt % by weight of components (i) and (ii).

9. The polymer blend material of claim 1, wherein component (iii) is present in an amount of 1-7 wt % by weight of components (i) and (ii).

10. The polymer blend material of claim 1, wherein component (iii) is present in an amount of 1-5 wt % by weight of components (i) and (ii).

11. The polymer blend material of claim 1, wherein said ceramic particles in component (iii) are ceramic oxide particles.

12. The polymer blend material of claim 11, wherein said ceramic oxide particles are silica particles.

13. The polymer blend material of claim 12, wherein said silica particles are fumed silica particles.

14. The polymer blend material of claim 1, wherein component (iii) comprises said ceramic particles in admixture with epoxy-functionalized ceramic particles.

15. The polymer blend material of claim 1, further comprising: (iv) a polyacrylonitrile-containing polymer blended with components (i), (ii), and (iii).

16. The polymer blend material of claim 1, further comprising: (v) an organic peroxide that crosslinks component (ii).

17. A method of bonding first and second surfaces together, the method comprising placing an adhesive composition between the first and second surfaces and hot pressing the surfaces at a temperature of 80° C. to 200° C., wherein the adhesive composition comprises:
(i) a lignin component;
(ii) a nitrile butadiene rubber component; and
(iii) a filler component selected from the group consisting of ceramic particles and carbon particles, wherein component (iii) is present in an amount of 0.1-10 wt % by weight of components (i) and (ii);
wherein component (i) is present in an amount of about 5 wt % to about 95 wt % by weight of components (i) and (ii).

18. The method of claim 17, wherein the particles in component (iii) have an average primary particle size of 1-100 nm.

19. The method of claim 17, wherein the particles in component (iii) are ceramic particles.

20. The method of claim 19, wherein the ceramic particles are ceramic oxide particles.

21. The method of claim 20, wherein said ceramic oxide particles are silica particles.

22. The method of claim 21, wherein said silica particles are fumed silica particles.

23. The method of claim 17, wherein component (iii) comprises said ceramic or carbon particles in admixture with epoxy-functionalized metal oxide particles.

24. The method of claim 23, wherein said epoxy-functionalized metal oxide particles have an average particle size of 1-50 microns.

25. The method of claim 17, wherein said temperature is 80° C. to 180° C.

26. The method of claim 17, wherein at least one of the first and second surfaces is a metal surface.

27. The method of claim 17, wherein at least one of the first and second surfaces is a polymer matrix composite surface.
